(19) United States
(12) Patent Application Publication
(10) Pub. No.: US 2025/0081233 A1
(43) Pub. Date: Mar. 6, 2025

(54) Method and Apparatus for Sidelink Transmission

(71) Applicant: Telefonaktiebolaget LM Ericsson (publ), Stockholm (SE)

(72) Inventors: Min Wang, Luleå (SE); Zhang Zhang, Beijing (CN)

(21) Appl. No.: 18/724,728

(22) PCT Filed: Mar. 7, 2023
(86) PCT No.: PCT/CN2023/080058

§ 371 Date: Jun. 27, 2024

(30) Foreign Application Priority Data
Mar. 22, 2022 (WO) PCT/CN2022/082334

(51) Int. Cl. H04W 74/0808; H04W 74/00; H04W 92/18

(52) U.S. Cl. CPC H04W 74/0808; H04W 74/002; H04W 92/18

(57) ABSTRACT

Various embodiments of the present disclosure provide a method for sidelink (SL) transmission. The method which may be performed by a user equipment (UE) comprises: performing a listen-before-talk (LBT) operation prior to a slot group comprising multiple slots. In accordance with an exemplary embodiment, the method further comprises: determining whether to select one or more slots from the multiple slots for one or more SL transmissions towards one or more other UEs, according to a result of the LBT operation.

### FIELD OF THE INVENTION

The present disclosure generally relates to communication networks, and more specifically, to a method and apparatus for sidelink (SL) transmission.

### BACKGROUND

This section introduces aspects that may facilitate a better understanding of the disclosure. Accordingly, the statements of this section are to be read in this light and are not to be understood as admissions about what is in the prior art or what is not in the prior art.

Communication service providers and network operators have been continually facing challenges to deliver value and convenience to consumers by, for example, providing compelling network services and performance. With the evolution of wireless communication, a requirement for supporting device-to-device (D2D) communication features in various applications is proposed. An extension for the D2D work may consist of supporting vehicle-to-everything (V2X) communication, which may include any combination of direct communications among vehicles, pedestrians and infrastructure. Wireless communication networks such as fourth generation (4G)/long term evolution (LTE) and fifth generation (5G)/new radio (NR) networks may be expected to use V2X services and support communication for V2X capable user equipment (UE).

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

D2D communications (also referred to as sidelink (SL) communications or communications over PC5 interface) between neighboring devices are specified by the 3rd generation partnership project (3GPP) in Release-12 (Rel-12). Some enhancements of the SL are introduced in subsequent releases for vehicle-to-vehicle (V2V) or V2X communications. In a wireless communication network supporting SL communications, an SL-capable UE may act as a relay UE which can provide the functionality to support connectivity to the network for another UE that may be out of cell coverage and may not be able to connect with the network directly. In some cases, a UE may communicate with another UE directly or via one or more relay UEs.

In order to achieve additional transmission capacity and increased data rate, besides the traditional licensed exclusive spectrum, the next generation communication systems such as 5G/NR are also expected to be operable on the unlicensed spectrum (also referred to as NR-U). Since the unlicensed spectrum may be shared by various radio devices, a listen-before-talk (LBT) procedure may need to be applied by a radio device before transmitting on a channel that uses the unlicensed spectrum. The LBT procedure requires the radio device to perform a clear channel assessment (CCA) to determine if the channel is available.

SL transmissions on the unlicensed spectrum (also referred to as SL-U) may be supported in the next 3GPP releases. A SL-capable UE may need to perform an LBT operation on a channel before a SL transmission so as to determine whether the channel is occupied by another UE. If the LBT operation does not succeed until a slot of a transmission occasion starts, this transmission occasion may not be used for the SL transmission and the UE may have to perform the SL transmission in the next transmission occasion, because the SL transmission only starts at slot boundaries. In some cases, the UE may need to perform another LBT operation before the next transmission occasion. This may lead to a waste of channel resources and introduce extra transmission delay. Therefore, it may be desirable to implement an SL transmission in a more efficient way.

Various exemplary embodiments of the present disclosure propose a solution for SL transmission, which may enable an LBT operation and SL transmission (e.g., periodic or non-periodic SL transmission, etc.) to be controlled flexibly and efficiently, e.g., on an unlicensed band.

It can be appreciated that a link or a radio link over which signals are transmitted between at least two UEs for D2D operations may be called in this document as SL. The signals transmitted between the UEs for D2D operations may be called in this document as SL signals. The terms “sidelink” and “SL” may also interchangeably be called as D2D link, V2X link, ProSe link, peer-to-peer link, PC5 link, etc. The SL signals may also interchangeably be called as V2X signals, D2D signals, ProSe signals, PC5 signals, peer-to-peer signals, etc.

According to a first aspect of the present disclosure, there is provided a method performed by a UE. The method comprises: performing an LBT operation prior to a slot group comprising multiple slots. In accordance with an exemplary embodiment, the method further comprises: determining whether to select one or more slots from the multiple slots for one or more SL transmissions towards one or more other UEs, according to a result of the LBT operation.

In accordance with an exemplary embodiment, when the IBT operation succeeds prior to or during the slot group, the UE may determine to select the one or more slots from the multiple slots for the one or more SL transmissions. In an embodiment, the UE may perform the one or more SL transmissions in the one or more selected slots.

In accordance with an exemplary embodiment, when the LBT operation succeeds prior to the slot group, the one or more selected slots in which the UE may perform the one or more SL transmissions may comprise one or more slots starting from a beginning slot in the slot group.

In accordance with an exemplary embodiment, when the LBT operation succeeds during a n-th slot in the slot group, the one or more selected slots in which the UE may perform the one or more SL transmissions may comprise one or more slots starting from a (n+1)-th slot in the slot group, where n is an integer equal to or larger than 1 and less than a size of the slot group.

In accordance with an exemplary embodiment, when there are one or more rest slots in the slot group after performing the one or more SL transmissions, the UE may skip the one or more rest slots.

In accordance with an exemplary embodiment, the method according to the first aspect of the present disclosure may further comprise: determining which service/quality of service (QOS) flow/bearer/logical channel (LCH)/logical channel group (LCG) is to be transmitted on one of the one or more selected slots, according to logical channel prioritization (LCP).

In accordance with an exemplary embodiment, the UE may perform one or more of the following actions to enable two consecutive slots in the one or more selected slots to be used for a first service/QoS flow/bearer/LCH/LCG and a second service/QoS flow/bearer/LCH/LCG, respectively:
mapping the first and second services to different QoS flows, when a maximum number of slots used for transmission is configured per service;
mapping the first and second QoS flows to different bearers, when the maximum number of slots used for transmission is configured per QoS flow;
mapping the first and second bearers to different LCHs, when the maximum number of slots used for transmission is configured per bearer; and
excluding the first LCH from an LCP procedure in one of the two consecutive slots which is to be used for the second service/QoS flow/bearer/LCH/LCG.

In accordance with an exemplary embodiment, the method according to the first aspect of the present disclosure may further comprise indicating in SL control information (SCI) one or more of: an index of a slot in the slot group in which the SCI is sent; and a rest number of slots in the slot group after the slot in which the SCI is sent.

In accordance with an exemplary embodiment, when the LBT operation succeeds during a last slot in the slot group or consistently fails during the multiple slots in the slot group, the UE may determine not to select any slot from the multiple slots for the one or more SL transmissions.

In accordance with an exemplary embodiment, the multiple slots in the slot group may be consecutive slots for initial transmission and/or retransmission.

In accordance with an exemplary embodiment, the one or more SL transmissions may comprise one or more initial transmissions and/or one or more retransmissions.

In accordance with an exemplary embodiment, the UE may be configured with two or more slot groups and perform an LBT operation per slot group. In an embodiment, the two or more slot groups may comprise: one or more slot groups for initial transmission and/or one or more slot groups for retransmission.

In accordance with an exemplary embodiment, the method according to the first aspect of the present disclosure may further comprise: obtaining configuration information related to the slot group. In an embodiment, the configuration information may be provided by a base station and/or another UE. Alternatively or additionally, the configuration information may be preconfigured.

In accordance with an exemplary embodiment, the configuration information may indicate one or more of: a size of the slot group; a time gap between a slot group for initial transmission and a slot group for retransmission; and a time interval between two consecutive slot groups for initial transmissions.

In accordance with an exemplary embodiment, the time gap between the slot group for the initial transmission and the slot group for the retransmission may be based at least in part on a hybrid automatic repeat request (HARQ) process.

In accordance with an exemplary embodiment, the time gap between the slot group for the initial transmission and the slot group for the retransmission may be reserved for a receiver UE to provide an acknowledgement of receiving the initial transmission to the UE. The receiver UE is a UE which is expected to receive the initial transmission.

In accordance with an exemplary embodiment, the time interval between the two consecutive slot groups for the initial transmissions may be based at least in part on a time interval of data arrival.

In accordance with an exemplary embodiment, the configuration information may be based at least in part on one or more of: channel occupancy; a channel busy ratio (CBR); a channel usage ratio (CR); a received signal strength indicator (RSSI); a number of LBT failures; a number of LBT success occasions; an LBT failure ratio; an LBT success ratio; one or more QoS requirements of a service/QoS flow/bearer/LCH/LCG; and a priority of the service/QoS flow/bearer/LCH/LCG.

In accordance with an exemplary embodiment, the configuration information may be determined per service/QoS flow/bearer/LCH/LCG, or based at least in part on one of services/QoS flows/bearers/LCHs/LCGs.

In accordance with an exemplary embodiment, the method according to the first aspect of the present disclosure may further comprise: transmitting the configuration information to one or more other UEs.

In accordance with an exemplary embodiment, the UE may perform the LBT operation in load based equipment (LBE) mode or frame based equipment (FBE) mode.

In accordance with an exemplary embodiment, the slot group may be a periodic slot group configured to the UE via one or more of: a configured grant for SL transmission; and Mode 2 resource allocation with resource reservation. In accordance with another exemplary embodiment, the slot group may be configured to be available for a non-periodic traffic of the UE.

According to a second aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the first aspect of the present disclosure.

According to a third aspect of the present disclosure, there is provided a computer-readable medium having computer program codes embodied thereon which, when executed on a computer, cause the computer to perform any step of the method according to the first aspect of the present disclosure.

According to a fourth aspect of the present disclosure, there is provided an apparatus which may be implemented as a UE. The apparatus may comprise a performing unit and a determining unit. In accordance with some exemplary embodiments, the performing unit may be operable to carry out at least the performing step of the method according to the first aspect of the present disclosure. The determining unit may be operable to carry out at least the determining step of the method according to the first aspect of the present disclosure.

According to a fifth aspect of the present disclosure, there is provided a method performed by a UE. The method comprises: obtaining configuration information related to a slot group comprising multiple slots. In accordance with an exemplary embodiment, the method further comprises: detecting one or more SL transmissions from another UE in one or more slots of the multiple slots, based at least in part on the configuration information.

In accordance with an exemplary embodiment, the multiple slots in the slot group may be consecutive slots for initial transmission and/or retransmission.

In accordance with an exemplary embodiment, the one or more SL transmissions may comprise one or more initial transmissions and/or one or more retransmissions.

In accordance with an exemplary embodiment, the method according to the fifth aspect of the present disclosure may further comprise: providing one or more acknowledgements of receiving at least one of the one or more SL transmissions to the another UE, in response to the receipt of the at least one of the one or more SL transmissions.

In accordance with an exemplary embodiment, the configuration information related to the slot group may be provided by a base station and/or the another UE. Alternatively or additionally, the configuration information may be preconfigured.

In accordance with an exemplary embodiment, the configuration information related to the slot group according to the fifth aspect of the present disclosure may correspond to the configuration information related to the slot group according to the first aspect of the present disclosure. Thus, the configuration information related to the slot group as described according to the first and fifth aspects of the present disclosure may have the same or similar contents and/or feature elements.

In accordance with an exemplary embodiment, there may be a time gap between the slot group for initial transmission and the slot group for retransmission. The time gap may be reserved for the UE to provide an acknowledgement of receiving the initial transmission to the another UE.

In accordance with an exemplary embodiment, the method according to the fifth aspect of the present disclosure may further comprise receiving SCI from the another UE. In an embodiment, the SCI may indicate one or more of: an index of a slot in the slot group in which the SCI is sent; and a rest number of slots in the slot group after the slot in which the SCI is sent.

According to a sixth aspect of the present disclosure, there is provided an apparatus which may be implemented as a UE. The apparatus may comprise one or more processors and one or more memories storing computer program codes. The one or more memories and the computer program codes may be configured to, with the one or more processors, cause the apparatus at least to perform any step of the method according to the fifth aspect of the present disclosure.

According to a seventh aspect of the present disclosure, there is provided a computer-readable medium having computer program codes embodied thereon which, when executed on a computer, cause the computer to perform any step of the method according to the fifth aspect of the present disclosure.

According to an eighth aspect of the present disclosure, there is provided an apparatus which may be implemented as a UE. The apparatus may comprise an obtaining unit and a detecting unit. In accordance with some exemplary embodiments, the obtaining unit may be operable to carry out at least the obtaining step of the method according to the fifth aspect of the present disclosure. The detecting unit may be operable to carry out at least the detecting step of the method according to the fifth aspect of the present disclosure.

According to a ninth aspect of the present disclosure, there is provided a method performed by a communication node. The method comprises: determining configuration information related to a slot group comprising multiple slots. In accordance with an exemplary embodiment, the method further comprises: transmitting the configuration information towards a UE. In an embodiment, in an event of a successful LBT operation of the UE prior to or during the slot group, one or more SL transmissions of the UE may be allowed in one or more slots of the multiple slots.

In accordance with an exemplary embodiment, the multiple slots in the slot group may be consecutive slots for initial transmission and/or retransmission.

In accordance with an exemplary embodiment, the configuration information related to the slot group according to the ninth aspect of the present disclosure may correspond to the configuration information related to the slot group according to the first aspect of the present disclosure. Thus, the configuration information related to the slot group as described according to the first and ninth aspects of the present disclosure may have the same or similar contents and/or feature elements.

In accordance with an exemplary embodiment, the method according to the ninth aspect of the present disclosure may further comprise: transmitting the configuration information towards one or more other UEs.

In accordance with an exemplary embodiment, the communication node may be a base station or a UE.

According to a tenth aspect of the present disclosure, there is provided an apparatus which may be implemented as a communication node. The apparatus may comprise one or more processors and one or more memories storing computer program codes. The one or more memories and the computer program codes may be configured to, with the one or more processors, cause the apparatus at least to perform any step of the method according to the ninth aspect of the present disclosure.

According to an eleventh aspect of the present disclosure, there is provided a computer-readable medium having computer program codes embodied thereon which, when executed on a computer, cause the computer to perform any step of the method according to the ninth aspect of the present disclosure.

According to a twelfth aspect of the present disclosure, there is provided an apparatus which may be implemented as a communication node. The apparatus may comprise a determining unit and a transmitting unit. In accordance with some exemplary embodiments, the determining unit may be operable to carry out at least the determining step of the method according to the ninth aspect of the present disclosure. The transmitting unit may be operable to carry out at least the transmitting step of the method according to the ninth aspect of the present disclosure.

According to a thirteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the method according to the ninth aspect of the present disclosure.

According to a fourteenth aspect of the present disclosure, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the method according to the ninth aspect of the present disclosure.

According to a fifteenth aspect of the present disclosure, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the method according to the first, fifth or ninth aspect of the present disclosure.

According to a sixteenth aspect of the present disclosure, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the method according to the first, fifth or ninth aspect of the present disclosure.

According to a seventeenth aspect of the present disclosure, there is provided a method implemented in a communication system which may include a host computer, a base station and a UE. The method may comprise, at the host computer, receiving user data transmitted to the base station from the UE which may perform any step of the method according to the first, fifth, or ninth aspect of the present disclosure.

According to an eighteenth aspect of the present disclosure, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the method according to the first, fifth, or ninth aspect of the present disclosure.

According to a nineteenth aspect of the present disclosure, there is provided a method implemented in a communication system which may include a host computer, a base station and a UE. The method may comprise, at the host computer, receiving, from the base station, user data originating from a transmission which the base station has received from the UE. The base station may perform any step of the method according to the ninth aspect of the present disclosure.

According to a twentieth aspect of the present disclosure, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the method according to the ninth aspect of the present disclosure.

According to various exemplary embodiments, a UE may select a slot or multiple slots in a slot group to perform one or more SL transmissions, when an LBT operation succeeds prior to or during the slot group. This can enable the UE to transmit SL data efficiently without performing an LBT operation per slot, improving resource utilization and enhancing service performance.

### BRIEF DESCRIPTION OF THE DRAWINGS

The disclosure itself, the preferable mode of use and further objectives are best understood by reference to the following detailed description of the embodiments when read in conjunction with the accompanying drawings, in which:

FIG. 1A is a diagram illustrating an exemplary semi-static channel occupancy operation according to an embodiment of the present disclosure;

FIG. 1B is a diagram illustrating an example of occurrence of LBT failures according to an embodiment of the present disclosure;

FIG. 2A is a diagram illustrating an example of slot groups according to an embodiment of the present disclosure;

FIG. 2B is a diagram illustrating another example of slot groups according to an embodiment of the present disclosure;

FIGS. 3-5 are flowcharts illustrating various methods according to some embodiments of the present disclosure;

FIGS. 6A-6D are block diagrams illustrating various apparatuses according to some embodiments of the present disclosure;

FIG. 7 is a block diagram illustrating a telecommunication network connected via an intermediate network to a host computer in accordance with some embodiments of the present disclosure;

FIG. 8 is a block diagram illustrating a host computer communicating via a base station with a UE over a partially wireless connection in accordance with some embodiments of the present disclosure;

FIG. 9 is a flowchart illustrating a method implemented in a communication system, in accordance with an embodiment of the present disclosure;

FIG. 10 is a flowchart illustrating a method implemented in a communication system, in accordance with an embodiment of the present disclosure;

FIG. 11 is a flowchart illustrating a method implemented in a communication system, in accordance with an embodiment of the present disclosure; and

FIG. 12 is a flowchart illustrating a method implemented in a communication system, in accordance with an embodiment of the present disclosure.

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “communication network” refers to a network following any suitable communication standards, such as new radio (NR), long term evolution (LTE), LTE-Advanced, wideband code division multiple access (WCDMA), high-speed packet access (HSPA), and so on. Furthermore, the communications between a terminal device and a network node in the communication network may be performed according to any suitable generation communication protocols, including, but not limited to, the first generation (1G), the second generation (2G), 2.5G, 2.75G, the third generation (3G), 4G, 4.5G, 5G communication protocols, and/or any other protocols either currently known or to be developed in the future.

The term “network node” refers to a network device in a communication network via which a terminal device accesses to the network and receives services therefrom. The network node may refer to a base station (BS), an access point (AP), a multi-cell/multicast coordination entity (MCE), a controller or any other suitable device in a wireless communication network. The BS may be, for example, a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth.

Yet further examples of the network node comprise multi-standard radio (MSR) radio equipment such as MSR BSs, network controllers such as radio network controllers (RNCs) or base station controllers (BSCs), base transceiver stations (BTSs), transmission points, transmission nodes, positioning nodes and/or the like. More generally, however, the network node may represent any suitable device (or group of devices) capable, configured, arranged, and/or operable to enable and/or provide a terminal device access to a wireless communication network or to provide some service to a terminal device that has accessed to the wireless communication network.

The term “terminal device” refers to any end device that can access a communication network and receive services therefrom. By way of example and not limitation, the terminal device may refer to a mobile terminal, a user equipment (UE), or other suitable devices. The UE may be, for example, a subscriber station, a portable subscriber station, a mobile station (MS) or an access terminal (AT). The terminal device may include, but not limited to, portable computers, image capture terminal devices such as digital cameras, gaming terminal devices, music storage and playback appliances, a mobile phone, a cellular phone, a smart phone, a tablet, a wearable device, a personal digital assistant (PDA), a vehicle, and the like.

As yet another specific example, in an Internet of things (IoT) scenario, a terminal device may also be called an IoT device and represent a machine or other device that performs monitoring, sensing and/or measurements etc., and transmits the results of such monitoring, sensing and/or measurements etc. to another terminal device and/or a network equipment. The terminal device may in this case be a machine-to-machine (M2M) device, which may in a 3rd generation partnership project (3GPP) context be referred to as a machine-type communication (MTC) device.

As one particular example, the terminal device may be a UE implementing the 3GPP narrow band Internet of things (NB-IoT) standard. Particular examples of such machines or devices are sensors, metering devices such as power meters, industrial machinery, or home or personal appliances, e.g. refrigerators, televisions, personal wearables such as watches etc. In other scenarios, a terminal device may represent a vehicle or other equipment, for example, a medical instrument that is capable of monitoring, sensing and/or reporting etc. on its operational status or other functions associated with its operation.

As used herein, the terms “first”, “second” and so forth refer to different elements. The singular forms “a” and “an” are intended to include the plural forms as well, unless the context clearly indicates otherwise. The terms “comprises”, “comprising”, “has”, “having”, “includes” and/or “including” as used herein, specify the presence of stated features, elements, and/or components and the like, but do not preclude the presence or addition of one or more other features, elements, components and/or combinations thereof. The term “based on” is to be read as “based at least in part on”. The term “one embodiment” and “an embodiment” are to be read as “at least one embodiment”. The term “another embodiment” is to be read as “at least one other embodiment”. Other definitions, explicit and implicit, may be included below.

Wireless communication networks are widely deployed to provide various telecommunication services such as voice, video, data, messaging and broadcasts. To meet dramatically increasing network requirements on traffic capacity and data rates, one interesting option for communication technique development is to allow D2D communications to be implemented in a wireless communication network such as 4G/LTE or 5G/NR network. As used herein, D2D may be referred to in a broader sense to include communications between any types of UEs, and include V2X communications between a vehicle UE and any other type of UE. D2D and/or V2X may be a component of many existing wireless technologies when it comes to direct communication between wireless devices. D2D and/or V2X communications as an underlay to cellular networks may be proposed as an approach to take advantage of the proximity of devices.

Next generation systems are expected to support a wide range of use cases with varying requirements ranging from fully mobile devices to stationary IoT or fixed wireless broadband devices. The traffic pattern associated with many use cases is expected to consist of short or long bursts of data traffic with varying length of waiting period in between (here called inactive state). In NR, both license assisted access (LAA) and standalone unlicensed operations are to be supported in 3GPP. Hence the procedure of physical random access channel (PRACH) transmission and/or scheduling request (SR) transmission in unlicensed spectrum may be investigated in 3GPP. Some descriptions about NR-U and channel access procedure for an unlicensed channel based on LBT is as below.

In order to tackle with the ever-increasing data demanding, NR may be supported on both licensed and unlicensed spectrum (i.e., referred to as NR-U). Compared to the LTE LAA, NR-U may support dual connectivity (DC) and standalone scenarios, where the medium access control (MAC) procedures including random access channel (RACH) and scheduling procedure on unlicensed spectrum are subject to the LBT failures, while there is no such restriction in LTE LAA, since there is the licensed spectrum in LAA scenario so the RACH and scheduling related signaling can be transmitted on the licensed spectrum instead of the unlicensed spectrum.

For discovery reference signal (DRS) transmission such as primary synchronization signal/secondary synchronization signal (PSS/SSS), physical broadcast channel (PBCH), channel state information-reference signal (CSI-RS), control channel transmission such as physical uplink control channel/physical downlink control channel (PUCCH/PDCCH), physical data channel such as physical uplink shared channel/physical downlink shared channel (PUSCH/PDSCH), and uplink sounding reference signal such as sounding reference signal (SRS) transmission, channel sensing may need to be applied to determine the channel availability before the physical signal is transmitted using the channel.

The radio resource management (RRM) procedures in NR-U may be generally rather similar as in LAA, since NR-U is aiming to reuse LAA/eLAA/feLAA technologies as much as possible to handle the coexistence between NR-U and other legacy radio access technologies (RATs). RRM measurements and report may comprise a special configuration procedure with respect to the channel sensing and channel availability.

Hence, channel access/selection for LAA may be one of important aspects for co-existence with other RATs such as Wi-Fi. For instance, LAA has aimed to use carriers that are congested with Wi-Fi.

In the licensed spectrum, a UE may measure reference signal received power (RSRP) and reference signal received quality (RSRQ) of the downlink radio channel (e.g., synchronization signal/physical broadcast channel block (SSB), CSI-RS), and provide the measurement reports to its serving eNB/gNB. However, the measurement reports may not reflect the interference strength on the carrier. Another metric such as received signal strength indicator (RSSI) can serve for such purpose. At the eNB/gNB side, it may be possible to derive RSSI based on the received RSRP and RSRQ reports, however, this may require that they are available. Due to the LBT failure, some reports in terms of RSRP or RSRP may be blocked (may be either due to that the reference signal transmission (e.g., demodulation reference signal (DRS)) is blocked in the downlink or the measurement report is blocked in the uplink). Hence, the measurements in terms of RSSI may be very useful. The RSSI measurements together with the time information concerning when and how long time that UEs have made the measurements can assist the gNB/eNB to detect the hidden node. Additionally, the gNB/eNB can measure the load situation of the carrier which is useful for the network to prioritize some channels for load balance and channel access failure avoidance purposes.

LTE LAA may support measurements of the averaged RSSI and channel occupancy for measurement reports. The channel occupancy is defined as percentage of time that the RSSI is measured above a configured threshold. For this purpose, a RSSI measurement timing configuration (RMTC) may include a measurement duration (e.g. 1˜5 ms) and a period between measurements (e.g. {40, 80, 160, 320, 640} ms).

3GPP Rel-16 WI NR-U specifies a dynamic channel access mechanism for an LBE type device. This procedure is designed to randomize the start of transmissions from different nodes that want to access the channel at the same time. This procedure is commonly known as category 4 (CAT4) LBT, the detailed procedure for category 4 LBT (also named as Type 1 channel access in 3GPP technical specification (TS) 37.213 V17.0.0) is described as below.

A UE may transmit the transmission using Type 1 channel access procedure after first sensing the channel to be idle during the slot durations of a defer duration T_{d}, and after the counter N is zero in step 4. The counter N is adjusted by sensing the channel for additional slot duration(s) according to the steps described below.
1) set N=Nᵢₙᵢₜ, where Nᵢₙᵢₜ is a random number uniformly distributed between 0 and CWₚ, and go to step 4;
2) if N>0 and the UE chooses to decrement the counter, set N=N−1;
3) sense the channel for an additional slot duration, and if the additional slot duration is idle, go to step 4; else, go to step 5;
4) if N=0, stop; else, go to step 2;
5) sense the channel until either a busy slot is detected within an additional defer duration T_{d} or all the slots of the additional defer duration T_{d} are detected to be idle;
6) if the channel is sensed to be idle during all the slot durations of the additional defer duration T_{d}, go to step 4; else, go to step 5.

If a UE has not transmitted a UL transmission on a channel on which UL transmission(s) are performed after step 4 in the procedure above, the UE may transmit a transmission on the channel, if the channel is sensed to be idle at least in a sensing slot duration Tₛₗ when the UE is ready to transmit the transmission and if the channel has been sensed to be idle during all the slot durations of a defer duration T_{d} immediately before the transmission. If the channel has not been sensed to be idle in a sensing slot duration Tₛₗ when the UE first senses the channel after it is ready to transmit, or if the channel has not been sensed to be idle during any of the sensing slot durations of a defer duration T_{d} immediately before the intended transmission, the UE proceeds to step 1 after sensing the channel to be idle during the slot durations of a defer duration T_{d}.

The defer duration T_{d} consists of duration T_{f}=16 us immediately followed by mₚ consecutive slot durations where each slot duration is Tₛₗ=9 μs, and T_{f} includes an idle slot duration Tₛₗ at start of T_{f}.

CW_{min,p}≤CWₚ≤CW_{max,p} is the contention window. CWₚ adjustment is described in clause 4.2.2 of 3GPP TS 37.213 V17.0.0. CW_{min,p} and CW_{max,p} are chosen before step 1 of the procedure above. mₚ, CW_{min,p}, and CW_{max,p} are based on a channel access priority class (CAPC) p as shown in Table 1 (which is corresponding to Table 4.2.1-1 in 3GPP TS 37.213 V17.0.0).

TABLE 1

| Channel | | | | | |
|---|---|---|---|---|---|
| Access | | | | | |
| Priority | | | | | allowed |
| Class (p) | mₚ | CW_{min p} | CW_{max p} | T [symbol] | CWₚ sizes |
| 1 | 2 | 3 | 7 | 2 ms | {3, 7} |
| 2 | 2 | 7 | 15 | 4 ms | {7, 15} |
| 3 | 3 | 15 | 1023 | 6 ms or 10 ms | {15, 31, 63, 127, |
| | | | | | 255, 511, 1023} |
| 4 | 7 | 15 | 1023 | 6 ms or 10 ms | (15, 31, 63, 127, |
| | | | | | 255, 511, 1023} |

NOTE1:
For p = 3.4 , T [symbol] = 10 ms if the higher layer parameter absenceOfAnyOtherTechnology-r14 or absenceOfAnyOtherTechnology-r16 is provided, otherwise, T [symbol] = 6 ms.
NOTE 2:
When T [symbol] = 6 ms it may be increased to 8 ms by inserting one or more gaps. The minimum duration of a gap may be 100 us. The maximum duration before including any such gap may be 6 ms. [symbol]
indicates data missing or illegible when filed

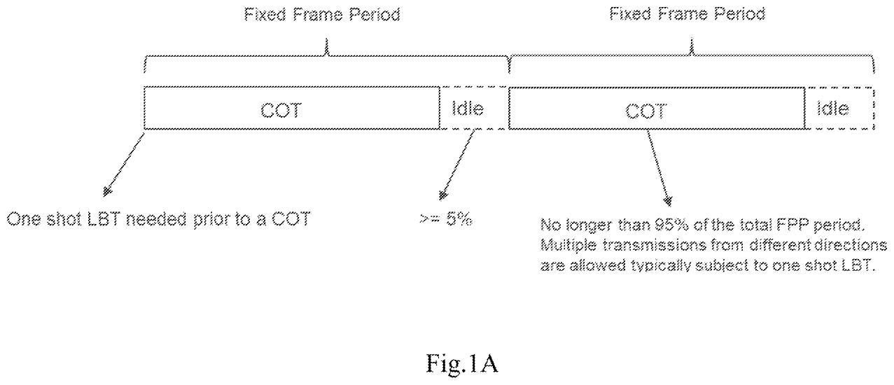

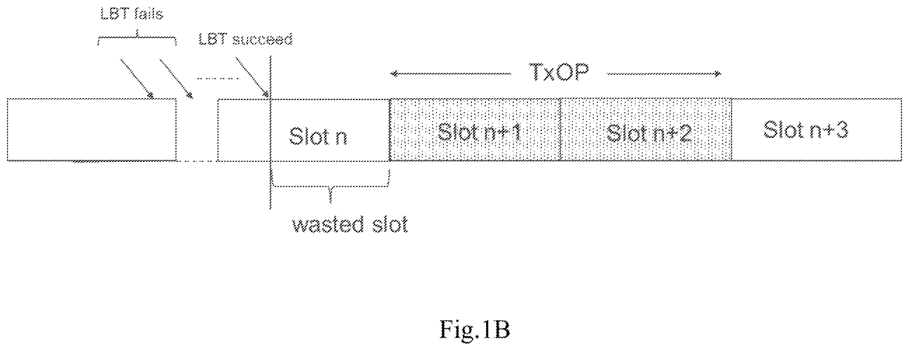

FIG. 1A is a diagram illustrating an exemplary semi-static channel occupancy operation according to an embodiment of the present disclosure. An example of the FBE based channel occupancy operation may be described with respect to FIG. 1A. The semi-static channel occupancy allows an FBE to perform a CCA per fixed frame period for a duration of single 9 μs observation slot. If the channel is found to be busy after CCA operation, the equipment may not transmit during this fixed frame period. The fixed frame period can be set to a value between 1 ms and 10 ms and can be adjusted once every 200 ms. If the channel is found to be idle, the equipment can transmit immediately up to a duration referred to as channel occupancy time, after which the equipment may remain silent for at least 5% of said channel occupancy time. At the end of the required idle period, the equipment can resume CCA for channel access.

The semi-static channel occupancy generally has difficulty competing with devices that use dynamic channel occupancy (such as LAA or NR-U) for channel access. Dynamic channel occupancy device has the flexibility to access the channel at any time after a successful LBT procedure, while the semi-static channel occupancy device has one chance for grabbing the channel every fixed frame period. The problems become more exacerbated with longer fixed frame period and higher traffic load. Secondly, the frame based LBT may be rather inflexible for coordinating channel access between networks. If all the nodes are synchronized, then all nodes may find the channel available and transmit simultaneously and cause interference. If the nodes are not synchronized, then some nodes may have definitive advantages in getting access to the channel over some other nodes. Nonetheless, semi-static channel occupancy may be a good choice for controlled environments, where a network owner can guarantee absence of dynamic channel occupancy devices and may be in control of the behavior of all devices competing to access the channel. In fact, in such deployment, semi-static channel occupancy may be an attractive solution because access latencies can be reduced to the minimum and lower complexity is required for channel access due to lack of necessity to perform random backoff.

In order to deploy a single operator FBE system, the gNBs may need to be time aligned. All gNBs may perform the one-shot 9 μs LBT at the same time. If the gNB indicates FBE operation, for an indication of LBT type of Cat2 25 μs or Cat4, the UE follows the mechanism whereby one 9 μs slot is measured within a 25 μs interval.

The fixed frame period (FFP) is restricted to values of {1 ms, 2 ms, 2.5 ms, 4 ms, 5 ms, 10 ms} (this is including the idle period). The starting positions of the FFPs within every two radio frames start from an even radio frame and are given by i*P where i={0, 1, . . . , 20/P−1}, where P is the fixed frame period in ms.

The idle period for a given subcarrier spacing (SCS)=ceil (Minimum idle period allowed by regulations/Ts), where the minimum idle period allowed=max (5% of FFP, 100 μs), and Ts is the symbol duration for the given SCS.

For FBE, channel sensing is performed at fixed time instants. If the channel is determined busy, the base station adopts a fixed back-off and performs LBT again after the fixed backoff. For LBE, channel sensing can be performed at any time instance, and random back-off is adopted when the channel is determined to be busy.

As described in 3GPP technical report (TR) 38.889 V16.0.0, it has been identified that FBE operation for the scenario where it is guaranteed that LBE nodes are absent on a long term basis (e.g., by level of regulation) and FBE gNBs are synchronized can achieve the following: ability to use frequency reuse factor 1; and lower complexity for channel access due to lack of necessity to perform random backoff. It is noted that this does not imply that LBE does not have benefits in similar scenarios although there are differences between the two modes of operation. It is also noted that FBE may also have some disadvantages compared to other modes of operation such as LBE, e.g., a fixed overhead for idle time during a frame.

In NR Rel-16, it is only gNB channel occupancy time (COT) sharing is supported in case of semi-static channel access by FBE. A UE may transmit UL transmission burst(s) after downlink (DL) transmission within a gNB initiated COT. UE transmissions within a fixed frame period can occur if DL transmission for the serving gNB within the fixed frame period is detected. The detection of any DL transmission confirms that the gNB has initiated the COT. For this to work, the UE may need to be aware of the start and end of every FFP cycle. Such UE behaviors are not optimum for ultra-reliable low latency communication (URLLC) like services that require critical latency requirements. The UE initiated COT by FBE may be a complementary solution for URLLC.

Sidelink transmissions over NR are specified by 3GPP in Rel-16. There are some enhancements of the ProSe (proximity-based services) specified for LTE. Four new enhancements are particularly introduced to NR sidelink transmissions as follows:
Support for unicast and groupcast transmissions are added in NR sidelink. For unicast and groupcast, the physical sidelink feedback channel (PSFCH) is introduced for a receiver (RX) UE to reply the decoding status to a transmitter (TX) UE.
Grant-free transmissions, which are adopted in NR uplink transmissions, are also provided in NR sidelink transmissions, to improve the latency performance.
To alleviate resource collisions among different sidelink transmissions launched by different UEs, it enhances channel sensing and resource selection procedures, which also lead to a new design of physical sidelink control channel (PSCCH).
To achieve a high connection density, congestion control and thus the QoS management is supported in NR sidelink transmissions.

To enable the above enhancements, new physical channels and reference signals are introduced in NR (available in LTE before):
PSSCH (Physical Sidelink Shared Channel, SL version of PDSCH): The PSSCH is transmitted by a sidelink transmitter UE, which conveys sidelink transmission data, system information blocks (SIBs) for radio resource control (RRC) configuration, and a part of the sidelink control information (SCI).
PSFCH (Physical Sidelink feedback channel): The PSFCH is transmitted by a sidelink receiver UE for unicast and groupcast, which conveys 1 bit information over 1 resource block (RB) for the HARQ acknowledgement (ACK) and the negative ACK (NACK). In addition, channel state information (CSI) is carried in the medium access control (MAC) control element (CE) over the PSSCH instead of the PSFCH.
PSCCH (Physical Sidelink Common Control Channel, SL version of PDCCH): When the traffic to be sent to a receiver UE arrives at a transmitter UE, a transmitter UE may need to first send the PSCCH, which conveys a part of SCI (SL version of downlink control information (DCI)) to be decoded by any UE for the channel sensing purpose, including the reserved time-frequency resources for transmissions, demodulation reference signal (DMRS) pattern and antenna port, etc.
Sidelink Primary/Secondary Synchronization Signal (S-PSS/S-SSS): Similar to downlink transmissions in NR, in sidelink transmissions, primary and secondary synchronization signals (called S-PSS and S-SSS, respectively) are supported. Through detecting the S-PSS and S-SSS, a UE is able to identify the sidelink synchronization identity (SSID) from the UE sending the S-PSS/S-SSS. Through detecting the S-PSS/S-SSS, a UE is therefore able to know the characteristics of the UE transmitter the S-PSS/S-SSS. A series of processes of acquiring timing and frequency synchronization together with SSIDs of UEs is called initial cell search. Note that the UE sending the S-PSS/S-SSS may not be necessarily involved in sidelink transmissions, and a node (UE/eNB/gNB) sending the S-PSS/S-SSS is called a synchronization source. There are 2 S-PSS sequences and 336 S-SSS sequences forming a total of 672 SSIDs in a cell.
Physical Sidelink Broadcast Channel (PSBCH): The PSBCH is transmitted along with the S-PSS/S-SSS as a synchronization signal/PSBCH block (SSB). The SSB has the same numerology as PSCCH/PSSCH on that carrier, and an SSB may need to be transmitted within the bandwidth of the configured bandwidth part (BWP). The PSBCH conveys information related to synchronization, such as the direct frame number (DFN), indication of the slot and symbol level time resources for sidelink transmissions, in-coverage indicator, etc. The SSB is transmitted periodically at every 160 ms.
Demodulation reference signal (DMRS), phase tracking reference signal (PT-RS), channel state information reference signal (CSIRS): These physical reference signals supported by NR downlink/uplink transmissions are also adopted by sidelink transmissions. Similarly, the PT-RS is only applicable for FR2 transmission.

Another new feature is the two-stage SCI. This is a version of the DCI for SL. Unlike the DCI, only part (first stage) of the SCI is sent on the PSCCH. This part is used for channel sensing purposes (including the reserved time-frequency resources for transmissions, DMRS pattern and antenna port, etc.) and can be read by all UEs while the remaining (second stage) scheduling and control information such as a 8-bits source identity (ID) and a 16-bits destination ID, new data indicator (NDI), redundancy version (RV) and HARQ process ID is sent on the PSSCH to be decoded by the receiver UE.

Similar as for ProSe in LTE, NR sidelink transmissions may have the following two modes of resource allocations:
Mode 1: Sidelink resources are scheduled by a gNB.
Mode 2: The UE autonomously selects sidelink resources from a (pre-)configured sidelink resource pool(s) based on the channel sensing mechanism.

For the in-coverage UE, a gNB can be configured to adopt Mode 1 or Mode 2. For the out-of-coverage UE, only Mode 2 can be adopted. As in LTE, scheduling over the sidelink in NR is done in different ways for Mode 1 and Mode 2.

Mode 1 may support the following two kinds of grants:
Dynamic grant: When the traffic to be sent over sidelink arrives at a transmitter UE, this UE may need to launch the four-message exchange procedure to request sidelink resources from a gNB (scheduling request (SR) on UL, grant, buffer status report (BSR) on UL, grant for data on SL sent to UE). During the resource request procedure, a gNB may allocate a sidelink radio network temporary identifier (SL-RNTI) to the transmitter UE. If this sidelink resource request is granted by a gNB, then a gNB indicates the resource allocation for the PSCCH and the PSSCH in the DCI conveyed by PDCCH with cyclic redundancy check (CRC) scrambled with the SL-RNTI. When a transmitter UE receives such DCI, a transmitter UE can obtain the grant only if the scrambled CRC of DCI can be successfully solved by the assigned SL-RNTI. A transmitter UE then indicates the time-frequency resources and the transmission scheme of the allocated PSSCH in the PSCCH, and launches the PSCCH and the PSSCH on the allocated resources for sidelink transmissions. When a grant is obtained from a gNB, a transmitter UE can only transmit a single transmission block (TB). As a result, this kind of grant is suitable for traffic with a loose latency requirement.
Configured grant: For the traffic with a strict latency requirement, performing the four-message exchange procedure to request sidelink resources may induce unacceptable latency. In this case, prior to the traffic arrival, a transmitter UE may perform the four-message exchange procedure and request a set of resources. If a grant can be obtained from a gNB, then the requested resources are reserved in a periodic manner. Upon traffic arriving at a transmitter UE, this UE can launch the PSCCH and the PSSCH on the upcoming resource occasion. In fact, this kind of grant is also known as grant-free transmissions.

In both dynamic grant and configured grant, a sidelink receiver UE may not be able to receive the DCI (since it is addressed to the transmitter UE), and therefore a receiver UE may need to perform blind decoding to identify the presence of PSCCH and find the resources for the PSSCH through the SCI. When a transmitter UE launches the PSCCH, CRC is also inserted in the SCI without any scrambling.

In the Mode 2 resource allocation, when traffic arrives at a transmitter UE, this transmitter UE may need to autonomously select resources for the PSCCH and the PSSCH. To further minimize the latency of the feedback HARQ ACK/NACK transmissions and subsequently retransmissions, a transmitter UE may also reserve resources for PSCCH/PSSCH for retransmissions. To further enhance the probability of successful TB decoding at one shot and thus suppress the probability to perform retransmissions, a transmitter UE may repeat the TB transmission along with the initial TB transmission. This mechanism is also known as blind retransmission. As a result, when traffic arrives at a transmitter UE, then this transmitter UE may need to select resources for the following transmissions:
1) The PSSCH associated with the PSCCH for initial transmission and blind retransmissions.
2) The PSSCH associated with the PSCCH for retransmissions.

Since each transmitter UE in sidelink transmissions may need to autonomously select resources for above transmissions, how to prevent different transmitter UEs from selecting the same resources turns out to be a critical issue in Mode 2. A particular resource selection procedure is therefore imposed to Mode 2 based on channel sensing. The channel sensing algorithm involves measuring RSRP on different subchannels and requires knowledge of the different UEs power levels of DMRS on the PSSCH or the DMRS on the PSCCH depending on the configuration. This information is known only after receiver SCI launched by (all) other UEs. The sensing and selection algorithm is rather complex.

For next 3GPP releases, sidelink transmission on unlicensed spectrum is a new technology which is attracting strong interest from various parties. In order to support sidelink transmission on unlicensed spectrum (SL-U), similar channel access mechanism as in NR-U may need to be introduced for SL-U. With channel access mechanism, a SL capable UE may need to perform an LBT operation prior to a SL transmission.

In accordance with some exemplary embodiments, certain features may be available for a SL UE enabling the UE to initiate periodic SL transmissions towards another SL UE. These features may comprise the configured grant for SL transmission and Mode 2 resource allocation with resource reservation. For the former feature, the UE may be configured with periodic configured grants for SL transmissions. For the latter feature, the UE can reserve periodic SL resources from resource pools autonomously, i.e., Mode 2 resource allocation for SL transmissions. For both features, these periodic SL resources may span in time and separated by time interval corresponding to the packet arrival interval for the SL transmissions.

In the case that a UE needs to perform periodic SL transmissions using either of the above features in unlicensed band, the UE may be required to perform an LBT operation prior to each transmission occasion. However, certain transmission occasion may be subject to LBT failures so that the UE may not be able to grasp the channel until the slot of a transmission occasion starts. Since SL transmission only starts at slot boundaries, so that the UE may not be able to perform SL transmission within the occasion. The packet has to be transmitted in the next transmission occasion, however, due to requirement of the packet delay budget, the packet may become out of dated and therefore need to be dropped. This may negatively affect QoS of the service. For a service with critical QoS requirement (e.g., public safety services with critical latency requirement), the QoS of the service may be not acceptable.

FIG. 1B is a diagram illustrating an example of occurrence of LBT failures according to an embodiment of the present disclosure. In this example, the UE has been experiencing LBT failures before slot n. The LBT operation eventually succeeds when slot n starts. The rest part of slot n may not be used by the UE for SL transmission although the channel has been grasped. The UE has to start SL transmission at slot n+1. In addition, the UE may have to re-perform LBT operation prior to slot n+1 to determine if the channel is still idle, if the rest period of the slot n is over a time gap during which there is not any transmission from the UE to occupy the channel so that the channel has been occupied by another UE.

Therefore, it may be desirable to study the above issues and develop solutions addressing at least one of the issues.

Various exemplary embodiments of the present disclosure propose solutions to enable a SL UE to achieve periodic SL transmissions, e.g., in an unlicensed band, towards one or multiple SL UEs. In accordance with an exemplary embodiment, the SL UE may obtain one or more slot groups and each slot group may comprise multiple slots for SL transmissions. The UE may perform an LBT operation prior to each slot group. Depending on outcome of the LBT operation, the UE may select one or multiple slots in the slot group. In an embodiment, the UE may select one or multiple slots stating from the beginning slot in the slot group if the LBT operation succeeds prior to the beginning slot in the slot group. In another embodiment, the UE may select one or multiple slots stating from slot n+1 in the slot group if the LBT operation succeeds during slot n in the slot group, where n=1, 2, . . . , N−1, and N is the total number of slots in the slot group. After selection of the slots from the slot group, the UE may use the selected slots to perform the SL transmissions (e.g., initial transmissions and/or retransmissions). Then the UE may skip the rest slot(s) in the slot group if there is any slot left. In a further embodiment, no slot in the slot group may be chosen by the UE if the LBT operation succeeds during the last slot of the slot group or the LBT operation consistently fails in all slots in the slot group.

Many advantages may be achieved by applying the proposed solutions. For example, it may be feasible for a SL UE to perform an LBT operation per slot group comprising multiple slots, and thus the channel utilization ratio may be improved by mitigating channel blocking due to LBT failures. In addition, QoS satisfaction of services may be improved since the UE can perform SL transmissions more efficiently.

It can be appreciated that although some exemplary embodiments are described in the context of NR, i.e., two or more SL UEs are deployed in a same or different NR cell, the same principle may be applied to LTE or any other technology that may enable the direct connection of two (or more) nearby devices. Various exemplary embodiments described in the present disclosure may also be applicable to relay scenarios including UE-to-Network relay or UE-to-UE relay where a remote UE and a relay UE may be based on LTE sidelink or NR sidelink, and the Uu connection between the relay UE and a base station may be LTE Uu or NR Uu.

Various embodiments described in the present disclosure may be applicable to SL unlicensed operations (i.e., SL transmission on an unlicensed band) or any other SL operations on a shared spectrum or a band with contention based access. The term LBT may also interchangeably called as CCA, shared spectrum access procedure, etc. The carrier on which the LBT is applied may belong to a shared spectrum or an unlicensed band or a band with contention based access, etc.

It also can be appreciated that various exemplary embodiments may be applicable to SL transmissions on the unlicensed band with any cast type including unicast, groupcast and broadcast. In addition, both LBE based channel access schemes (may also be named as dynamic channel access) and FBE based channel access schemes (may also be named as semi-static channel access) may be covered in various exemplary embodiments.

For a SL BWP configured to a UE, the BWP may contain multiple bandwidth segments referred to as e.g., channel, sub-band, BWP segment etc., and for each segment, it may be configured with different parameters such as SCS, symbol duration, cyclic prefix (CP) length, etc. In this case, the UE may perform an LBT operation per channel/subband/BWP segment.

In accordance with an exemplary embodiment, for each periodic transmission opportunity, e.g., to serve transmission of a periodic packet/frame/data unit/TB, a SL UE may be configured with or obtain multiple consecutive slots/transmission occasions in time, i.e., referred to as a slot group. Within each slot group, the UE may be allowed to use one slot/occasion out of all slots/occasions belonging to the slot group, to perform one transmission. The transmission may comprise an initial transmission of a TB/data unit or a retransmission of a TB/data unit. In this way, the negative impact for SL transmission due to LBT failures may be mitigated.

In accordance with an exemplary embodiment, the UE may perform an LBT operation prior to each slot group. Depending on outcome of the LBT operation, the UE may choose a slot in the slot group as the following cases.
Case 1.1: choose the first slot in the slot group if the LBT operation succeeds prior to the first slot;
Case 1.2: choose the slot n+1 in the slot group if the LBT operation succeeds during the slot n; and
Case 1.3: no slot may be chosen if the LBT operation succeeds during the last slot or the LBT operation consistently fails in all slots in the slot group.

For Case 1.1 and Case 1.2, after selection of a slot in the slot group, the UE may use the selected slot to perform SL transmission. After that, the UE may skip the rest slot(s) in the slot group if there is any slot left.

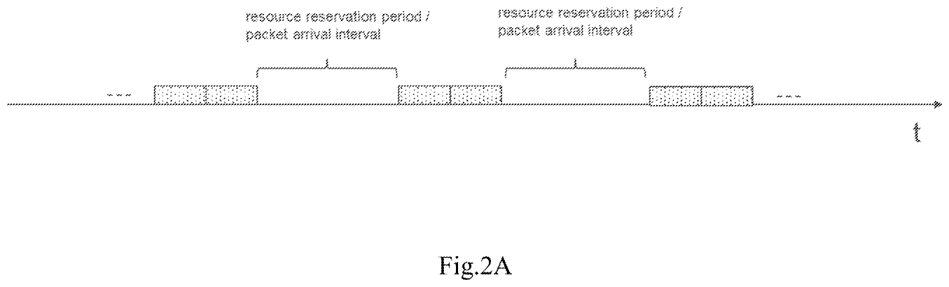

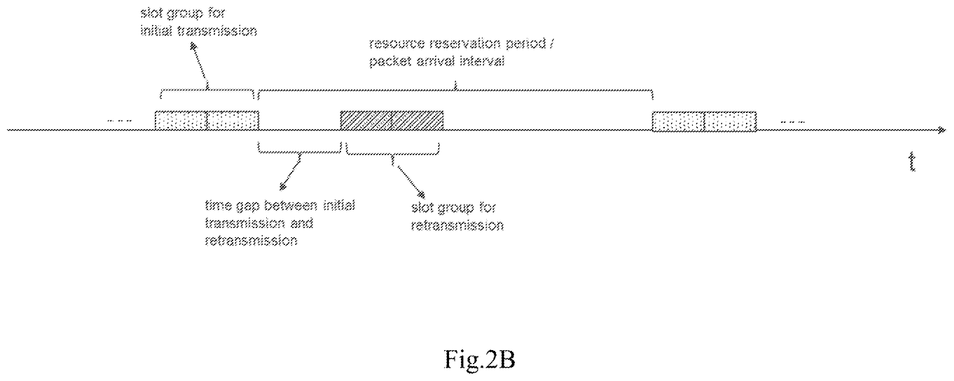

FIG. 2A is a diagram illustrating an example of slot groups according to an embodiment of the present disclosure. In the example as shown in FIG. 2A, a slot group contains two consecutive slots for an initial transmission of a TB or a retransmission of a TB. The time interval between two slot groups may be set equal to the time interval of TB/data unit arrival. In an embodiment, when an LBT operation succeeds prior to or during the slot group, a UE may use one of the slots for transmission, e.g., either initial transmission or retransmission.

FIG. 2B is a diagram illustrating another example of slot groups according to an embodiment of the present disclosure. In the example as shown in FIG. 2B, different slot groups are defined/configured to a UE, where some slot groups are for initial transmission while other slot groups are for retransmission. A slot group for initial transmission may be separated from another slot group for retransmission with a time gap, which is reserved for a RX UE to provide an acknowledgement (e.g., HARQ acknowledgement) to a TX UE upon reception of a transmission from the TX UE. The time interval between two slot groups for initial transmission may be set equal to the time interval of TB/data unit arrival.

In accordance with an exemplary embodiment, one or more parameters for configuring a slot group (also called slot group configuration parameters) may comprise at least one of the following:
the number of slots in a slot group (also referred to as time duration of a slot group, or size of a slot group), where the slots may be allowed for transmissions comprising initial transmissions only, retransmissions only, or both initial transmissions and retransmissions;
the allowed time gap between a slot group for initial transmission and a slot group for retransmission; and
the time interval between two consecutive slot groups, i.e., from the end of the last slot in one slot group for the n-th transmission to the start of the first slot in the next slot group for the (n+1)-th transmission.

In accordance with an exemplary embodiment, one or more parameters for configuring a slot group may be provided to a UE by a gNB via at least one of the following signaling alternatives:
system information/common signaling alternative;
dedicated RRC signaling;
paging message;
MAC control element (CE); and
Layer 1 signaling carried by physical channels including e.g., PDCCH, PDSCH, etc.

In accordance with an exemplary embodiment, one or more parameters for configuring a slot group may be provided to the UE by another UE (e.g., a controlling UE, etc.) via at least one of the following signaling alternatives:
RRC signaling (e.g., PC5-RRC);
PC5-S signaling;
discovery message;
MAC CE; and
Layer 1 signaling carried by physical channels including e.g., PSSCH, PSCCH, PSFCH, etc.

Alternatively or additionally, one or more parameters for configuring a slot group may be preconfigured to the UE or hard coded in the specification.

In accordance with an exemplary embodiment, a slot group may be configured to or obtained by a UE, the slot group containing multiple consecutive slots/transmission opportunities for multiple initial transmissions or retransmissions. The UE may be allowed to use more than one slot/transmission opportunity belonging to the slot group for initial transmissions and/or retransmissions. In an embodiment, the UE may perform an LBT operation prior to the slot group. Depending on outcome of the LBT operation, the UE may choose multiple slots in the slot group as the following cases.
Case 2.1: choose multiple slots stating from the first slot in the slot group if the LBT operation succeeds prior to the first slot;
Case 2.2: choose multiple slots stating from the slot n+1 in the slot group if the LBT operation succeeds during the slot n; and
Case 2.3: no slot may be chosen if the LBT operation succeeds during the last slot or the LBT operation consistently fails in all slots in the slot group.

For Case 2.1 and Case 2.2, after selection of the slots in the slot group, the UE may use the selected slots to perform multiple SL transmissions. The SL transmissions may comprise only initial transmissions, only retransmissions, or both initial transmissions and retransmissions. After that, the UE may skip the rest slot(s) in the slot group if there is any slot left. In an embodiment, the UE may just use all the rest slot(s), e.g., starting from slot n+1 in the slot group after the LBT operation succeeds in the previous slot (e.g., slot n).

In accordance with an exemplary embodiment, one or more parameters for configuring a slot group may be provided to the UE by considering measurement results/statistics in terms of at least one of the following metrics:
channel occupancy;
CBR;
CR;
RSSI;
the number of LBT failures/LBT success occasions;
an LBT failure ratio (defined as the number of LBT failures versus the total number of LBT occasions); and
an LBT success ratio (defined as the number of LBT success occasion versus the total number of LBT occasions).

It is noted that the measurements in any one of the above metrics may be performed during a configured time period or within a configured frequency region.

In accordance with an exemplary embodiment, the size of a slot group may be configured with a higher value if there is the high number of LBT failures (or the low number of LBT success occasions) are observed. In accordance with another exemplary embodiment, the size of a slot group may be configured with a lower value if there is the low number of LBT failures (or the high number of LBT success occasions) are observed.

In accordance with an exemplary embodiment, one or more parameters for configuring a slot group may be determined depending on the QoS requirement of a service/QoS flow/bearer/LCH/LCG. For instance, a larger slot group size and/or a larger (maximum) number of slots in the slot group that are allowed to be used for transmission if the service/QoS flow/bearer/LCH has a lower latency requirement. On the contrary, a lower slot group size and/or a lower (maximum) number of slots in each slot group that are allowed to be used for transmission if the service/QoS flow/bearer/LCH has a higher latency requirement.

In accordance with an exemplary embodiment, for the case of mixed services, one or more configuration parameters for a slot group may be set by considering QoS requirements of the service/QOS flow/bearer/LCH/LCG with the highest priority. In accordance with another exemplary embodiment, one or more configuration parameters for a slot group may be set per service/QoS flow/bearer/LCH/LCG.

In accordance with an exemplary embodiment, a first service/QoS flow/bearer/LCH/LCG can only be transmitted once (i.e., using one slot) in a slot group while a second service/QoS flow/bearer/LCH/LCG can be transmitted twice (i.e., using two slots) in a slot group, and slot n is the first available slot in the slot group according to the LBT result, then in slot n both the first and the second service/QoS flow/bearer/LCH/LCG can be transmitted and which one to transmit may depend on the output of logical channel prioritization (LCP).

In accordance with another exemplary embodiment, a first service/QoS flow/bearer/LCH/LCG is transmitted in slot n, then in slot n+1 only a second service/QoS flow/bearer/LCH/LCG can be transmitted, which may be implemented via one or more of:
not mapping the first service and the second service to the same QoS flow if the (maximum) number of slots used for transmission is configured per service;
not mapping the first QoS flow and the second QoS flow to the same bearer if the (maximum) number of slots used for transmission is configured per QoS flow;
not mapping the first bearer and the second bearer onto the same LCH if the (maximum) number of slots used for transmission is configured per bearer; and
excluding the first LCH from the LCP procedure in slot n+1.

In accordance with an exemplary embodiment, a UE (e.g., a TX UE, etc.) may indicate at least one of the following information in SCI:
the index of the slot in the current slot group wherein the SCI is sent, e.g., the slot may be the X-th slot in the current slot group; and
the rest number of slots in the slot group after the slot wherein the SCI is sent.

Considering such information in the SCI and/or the one or more parameters for configuring a slot group, a neighbor UE receiving the SCI can know the exact position of the current slot group and the future slot groups, and thus can avoid using slots or slot groups which are not available due to congestion, e.g., determined based on sensing results in case of Mode 2 resource allocation.

In accordance with an exemplary embodiment, a UE such as a RX UE may not be able to receive an expected SL transmission at a slot in a slot group from another UE such as a TX UE. In this case, the RX UE may continuously monitor the subsequent slots after that slot in the slot group. The number of subsequent slots which may need to be minored by the RX UE for the expected SL transmission can be determined by the RX UE according to at least the slot group configuration parameter(s). In an embodiment, the slot group configuration parameter(s) may be provided to the RX UE via one or more signaling messages from a gNB, including but not limited to system information/common signaling alternative, dedicated RRC signaling, paging message, MAC CE, and Layer 1 signaling carried by physical channels such as PDCCH, PDSCH, etc. In another embodiment, the slot group configuration parameter(s) may be provided to the RX UE via one or more signaling messages from the peer UE (e.g., the TX UE), including but not limited to RRC signaling (e.g., PC5-RRC), PC5-S signaling, discovery message, MAC CE, and Layer 1 signaling carried by physical channels including e.g., PSSCH, PSCCH, PSFCH, etc. Alternatively or additionally, the slot group configuration parameter(s) may be preconfigured to the RX UE.

In accordance with an exemplary embodiment, a UE such as a TX UE may perform an LBT operation in LBE mode. In this case, the LBT operation may be performed by the TX UE in any time (e.g., at slot boundaries or during any slot).

In accordance with an exemplary embodiment, a UE such as a TX UE may perform an LBT operation in FBE mode. In this case, the LBT operation may be performed by the TX UE per fixed frame period for a given duration. If the channel is found to be busy after the LBT operation, the TX UE may not transmit during this fixed frame period. If the channel is found to be idle after the LBT operation, the TX UE may skip the LBT operation during the rest frame period.

In accordance with an exemplary embodiment, a UE such as a TX UE may obtain periodic transmission occasions/opportunities (i.e., a periodic slot group) via a configured grant for SL transmission and/or Mode 2 resource allocation with resource reservation.

It is noted that some embodiments of the present disclosure are mainly described in relation to 4G/LTE or 5G/NR specifications being used as non-limiting examples for certain exemplary network configurations and system deployments. As such, the description of exemplary embodiments given herein specifically refers to terminology which is directly related thereto. Such terminology is only used in the context of the presented non-limiting examples and embodiments, and does naturally not limit the present disclosure in any way. Rather, any other system configuration or radio technologies may equally be utilized as long as exemplary embodiments described herein are applicable.

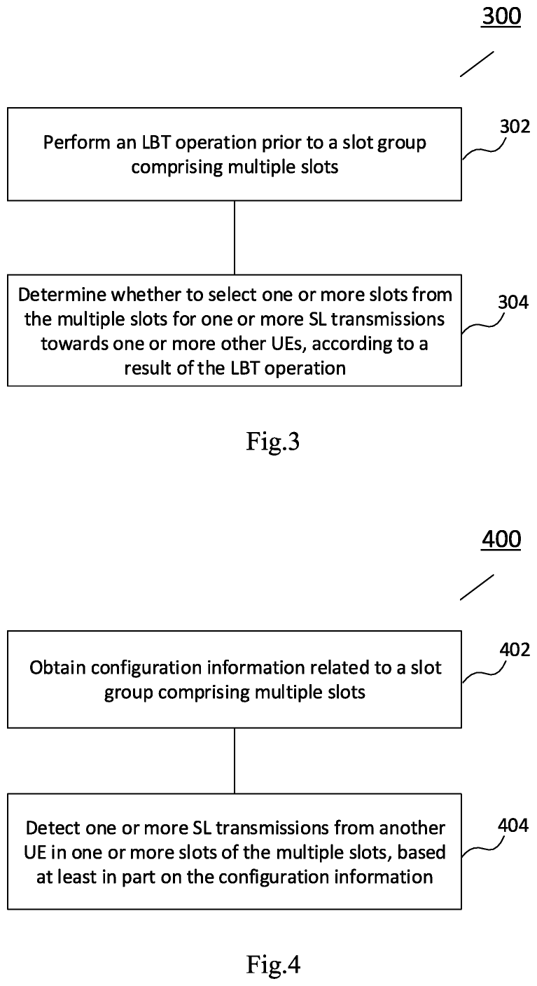

FIG. 3 is a flowchart illustrating a method 300 according to some embodiments of the present disclosure. The method 300 illustrated in FIG. 3 may be performed by a UE or an apparatus communicatively coupled to the UE. In accordance with an exemplary embodiment, the UE may be configured to support D2D communication (e.g., V2X or SL communication, etc.) with other devices. In an exemplary embodiment, the UE may be configured to communicate with a network node (e.g., a base station such as gNB, etc.) directly or via a relay UE.

According to the exemplary method 300 illustrated in FIG. 3, the UE may perform an LBT operation prior to a slot group comprising multiple slots, as shown in block 302. According to a result of the LBT operation, the UE may determine whether to select one or more slots from the multiple slots for one or more SL transmissions towards one or more other UEs, as shown in block 304.

In accordance with an exemplary embodiment, when the LBT operation succeeds prior to or during the slot group, the UE may determine to select the one or more slots from the multiple slots for the one or more SL transmissions. In an embodiment, the UE may perform the one or more SL transmissions in the one or more selected slots.

In accordance with an exemplary embodiment, when the LBT operation succeeds prior to the slot group, the one or more selected slots in which the UE may perform the one or more SL transmissions may comprise one or more slots starting from a beginning slot in the slot group.

In accordance with an exemplary embodiment, when the LBT operation succeeds during a n-th slot in the slot group, the one or more selected slots in which the UE may perform the one or more SL transmissions may comprise one or more slots starting from a (n+1)-th slot in the slot group, where n is an integer equal to or larger than 1 and less than a size of the slot group.

In accordance with an exemplary embodiment, when there are one or more rest slots in the slot group after performing the one or more SL transmissions, the UE may skip the one or more rest slots.

In accordance with an exemplary embodiment, the UE may determine which service/QoS flow/bearer/LCH/LCG is to be transmitted on one of the one or more selected slots, according to LCP.

In accordance with an exemplary embodiment, the UE may perform one or more of the following actions to enable two consecutive slots in the one or more selected slots to be used for a first service/QoS flow/bearer/LCH/LCG and a second service/QoS flow/bearer/LCH/LCG, respectively:
mapping the first and second services to different QoS flows, when the maximum number of slots used for transmission is configured per service;
mapping the first and second QoS flows to different bearers, when the maximum number of slots used for transmission is configured per QoS flow;
mapping the first and second bearers to different LCHs, when the maximum number of slots used for transmission is configured per bearer; and
excluding the first LCH from an LCP procedure in one of the two consecutive slots which is to be used for the second service/QoS flow/bearer/LCH/LCG.

In accordance with an exemplary embodiment, the UE may indicate in SCI one or more of: an index of a slot in the slot group in which the SCI is sent; and a rest number of slots in the slot group after the slot in which the SCI is sent.

In accordance with an exemplary embodiment, when the LBT operation succeeds during a last slot in the slot group or consistently fails during the multiple slots in the slot group, the UE may determine not to select any slot from the multiple slots for the one or more SL transmissions.

In accordance with an exemplary embodiment, the multiple slots in the slot group may be consecutive slots for initial transmission and/or retransmission.

In accordance with an exemplary embodiment, the one or more SL transmissions may comprise one or more initial transmissions and/or one or more retransmissions.

In accordance with an exemplary embodiment, the UE may be configured with two or more slot groups and perform an LBT operation per slot group. In an embodiment, the two or more slot groups may comprise: one or more slot groups for initial transmission and/or one or more slot groups for retransmission.

In accordance with an exemplary embodiment, the UE may obtain configuration information related to the slot group. In an embodiment, the configuration information may be provided by a base station (e.g., a gNB, etc.) and/or another UE (e.g., a controlling UE, etc.). Alternatively or additionally, the configuration information may be preconfigured to the UE.

In accordance with an exemplary embodiment, the configuration information related to the slot group may indicate one or more of: a size of the slot group; a time gap between a slot group for initial transmission and a slot group for retransmission; and a time interval between two consecutive slot groups for initial transmissions.

In accordance with an exemplary embodiment, the time gap between the slot group for the initial transmission and the slot group for the retransmission may be based at least in part on an HARQ process. In an embodiment, the time gap between the slot group for the initial transmission and the slot group for the retransmission may be reserved for a receiver UE (e.g., a UE which is expected to receive the initial transmission) to provide an acknowledgement (e.g., an HARQ acknowledgement, etc.) of receiving the initial transmission to the UE.

In accordance with an exemplary embodiment, the time interval between the two consecutive slot groups for the initial transmissions may be based at least in part on a time interval of data arrival.

In accordance with an exemplary embodiment, the configuration information related to the slot group may be based at least in part on one or more of: channel occupancy; a CBR; a CR; a RSSI; a number of LBT failures; a number of LBT success occasions; an LBT failure ratio; an LBT success ratio; one or more QoS requirements of a service/QoS flow/bearer/LCH/LCG; and a priority of the service/QoS flow/bearer/LCH/LCG.

In accordance with an exemplary embodiment, the configuration information related to the slot group may be determined per service/QoS flow/bearer/LCH/LCG. In accordance with another exemplary embodiment, the configuration information related to the slot group may be based at least in part on one of services/QoS flows/bearers/LCHs/LCGs (e.g., the one with the highest priority, etc.).

In accordance with an exemplary embodiment, the UE may transmit the configuration information related to the slot group to one or more other UEs (e.g., the peer UE, etc.).

In accordance with an exemplary embodiment, the UE may perform the LBT operation in LBE mode or FBE mode.

In accordance with an exemplary embodiment, the slot group may be a periodic slot group configured to the UE via one or more of: a configured grant for SL transmission; and Mode 2 resource allocation with resource reservation. It can be appreciated that the slot group may also be configured in other appropriate ways, e.g., for non-periodic SL transmission, and the same advantages can also be obtained for a non-periodic traffic when the slot group is granted to the UE. In accordance with another exemplary embodiment, the slot group may be configured to be available for a non-periodic traffic of the UE. Optionally, the slot group available for the non-periodic traffic may be configured to the UE via a configured grant for SL transmission and/or via Mode 2 resource allocation with resource reservation.

FIG. 4 is a flowchart illustrating a method 400 according to some embodiments of the present disclosure. The method 400 illustrated in FIG. 4 may be performed by a UE or an apparatus communicatively coupled to the UE. In accordance with an exemplary embodiment, the UE may be configured to support D2D communication (e.g., V2X or SL communication, etc.) with other devices. In an exemplary embodiment, the UE may be configured to communicate with a network node (e.g., a base station such as gNB, etc.) directly or via a relay UE.

According to the exemplary method 400 illustrated in FIG. 4, the UE may obtain configuration information related to a slot group comprising multiple slots, as shown in block 402. Based at least in part on the configuration information, the UE may detect one or more SL transmissions from another UE (e.g., the UE as described with respect to FIG. 3) in one or more slots of the multiple slots, as shown in block 404.

In accordance with an exemplary embodiment, the multiple slots in the slot group may be consecutive slots for initial transmission and/or retransmission. In accordance with another exemplary embodiment, the one or more SL transmissions may comprise one or more initial transmissions and/or one or more retransmissions.

In accordance with an exemplary embodiment, the UE may provide one or more acknowledgements of receiving at least one of the one or more SL transmissions to the another UE, in response to the receipt of the at least one of the one or more SL transmissions.

In accordance with an exemplary embodiment, the configuration information related to the slot group may be provided by a base station (e.g., a gNB, etc.) and/or the another UE (e.g., the UE as described with respect to FIG. 3). Alternatively or additionally, the configuration information may be preconfigured to the UE.

In accordance with an exemplary embodiment, the configuration information related to the slot group according to the method 400 may correspond to the configuration information related to the slot group according to the method 300. Thus, the configuration information related to the slot group as described with respect to FIG. 3 and FIG. 4 may have the same or similar contents and/or feature elements.

In accordance with an exemplary embodiment, there may be a time gap between the slot group for initial transmission and the slot group for retransmission. The time gap may be reserved for the UE to provide an acknowledgement of receiving the initial transmission to the another UE.

In accordance with an exemplary embodiment, the UE may receive SCI from the another UE (e.g., the UE as described with respect to FIG. 3). In an embodiment, the SCI may indicate one or more of: an index of a slot in the slot group in which the SCI is sent; and a rest number of slots in the slot group after the slot in which the SCI is sent.

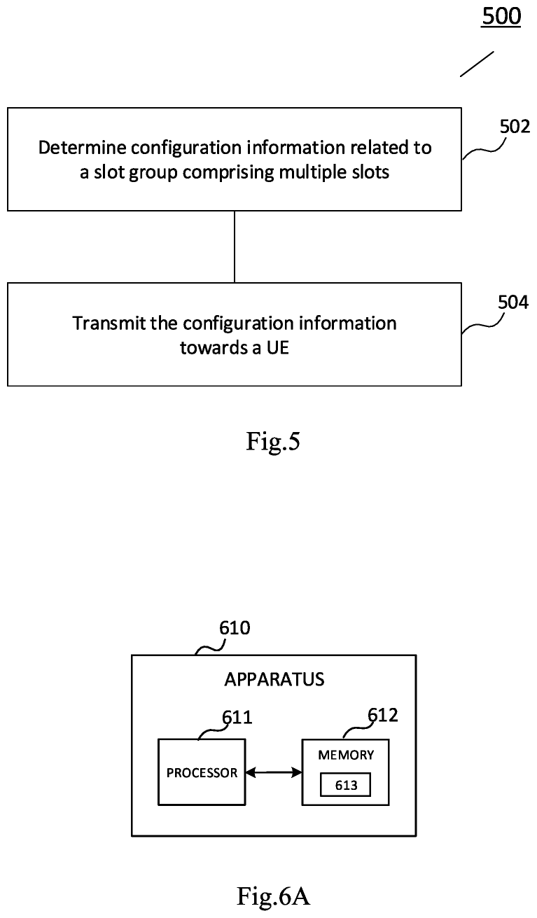

FIG. 5 is a flowchart illustrating a method 500 according to some embodiments of the present disclosure. The method 500 illustrated in FIG. 5 may be performed by a communication node (e.g., a base station, a UE, etc.) or an apparatus communicatively coupled to the communication node. In accordance with an exemplary embodiment, the communication node may be configured to act as a base station to support cellular coverage extension with D2D communication (e.g., V2X or SL communication, etc.). For example, the base station may be configured to communicate with a terminal device such as a UE, e.g. directly or via a relay UE. In accordance with another exemplary embodiment, the communication node may be configured to act as a UE to control one or more other UEs (e.g., by managing resource allocation and/or traffic scheduling) via D2D communication such as V2X or SL communication, etc.

According to the exemplary method 500 illustrated in FIG. 5, the communication node may determine configuration information related to a slot group comprising multiple slots, as shown in block 502. In accordance with an exemplary embodiment, the communication node may transmit the configuration information towards a UE (e.g., the UE as described with respect to FIG. 3), as shown in block 504. In an embodiment, in an event of a successful LBT operation of the UE prior to or during the slot group, one or more SL transmissions of the UE may be allowed in one or more slots of the multiple slots.

In accordance with an exemplary embodiment, the multiple slots in the slot group may be consecutive slots for initial transmission and/or retransmission.

In accordance with an exemplary embodiment, the configuration information related to the slot group according to the method 500 may correspond to the configuration information related to the slot group according to the method 300. Thus, the configuration information related to the slot group as described with respect to FIG. 3 and FIG. 5 may have the same or similar contents and/or feature elements.

In accordance with an exemplary embodiment, the communication node may transmit the configuration information towards one or more other UEs (e.g., the UE as described with respect to FIG. 4, etc.).

It can be appreciated that the UE as described with respect to FIG. 3 may also be configured to perform the method 400 as described with respect to FIG. 4 and/or the method 500 as described with respect to FIG. 5, according to different application scenarios and service requirements.

Similarly, it can be appreciated that the UE as described with respect to FIG. 4 may also be configured to perform the method 300 as described with respect to FIG. 3 and/or the method 500 as described with respect to FIG. 5, according to different application scenarios and service requirements.

Similarly, it can be appreciated that the UE as described with respect to FIG. 5 may also be configured to perform the method 300 as described with respect to FIG. 3 and/or the method 400 as described with respect to FIG. 4, according to different application scenarios and service requirements.

The various blocks shown in FIGS. 3-5 may be viewed as method steps, and/or as operations that result from operation of computer program code, and/or as a plurality of coupled logic circuit elements constructed to carry out the associated function(s). The schematic flow chart diagrams described above are generally set forth as logical flow chart diagrams. As such, the depicted order and labeled steps are indicative of specific embodiments of the presented methods. Other steps and methods may be conceived that are equivalent in function, logic, or effect to one or more steps, or portions thereof, of the illustrated methods. Additionally, the order in which a particular method occurs may or may not strictly adhere to the order of the corresponding steps shown.

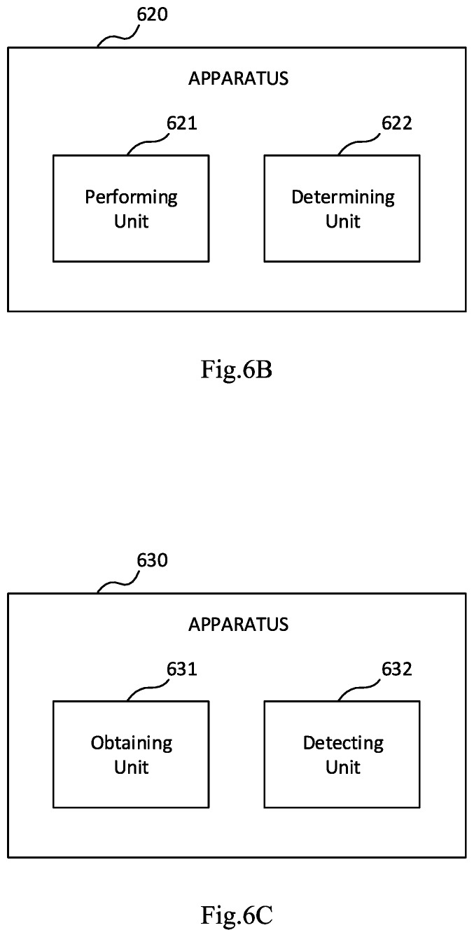

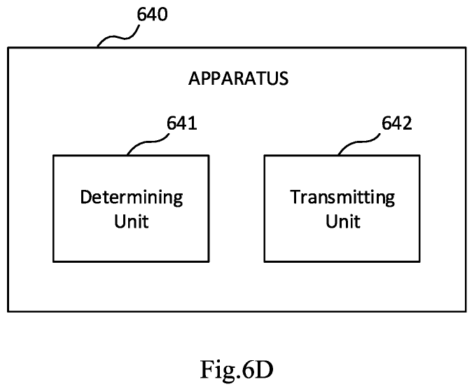

FIG. 6A is a block diagram illustrating an apparatus 610 according to various embodiments of the present disclosure. As shown in FIG. 6A, the apparatus 610 may comprise one or more processors such as processor 611 and one or more memories such as memory 612 storing computer program codes 613. The memory 612 may be non-transitory machine/processor/computer readable storage medium. In accordance with some exemplary embodiments, the apparatus 610 may be implemented as an integrated circuit chip or module that can be plugged or installed into a UE as described with respect to FIG. 3, a UE as described with respect to FIG. 4, or a communication node as described with respect to FIG. 5. In such cases, the apparatus 610 may be implemented as a UE as described with respect to FIG. 3, a UE as described with respect to FIG. 4, or a communication node as described with respect to FIG. 5.

In some implementations, the one or more memories 612 and the computer program codes 613 may be configured to, with the one or more processors 611, cause the apparatus 610 at least to perform any operation of the method as described in connection with FIG. 3. In other implementations, the one or more memories 612 and the computer program codes 613 may be configured to, with the one or more processors 611, cause the apparatus 610 at least to perform any operation of the method as described in connection with FIG. 4. In other implementations, the one or more memories 612 and the computer program codes 613 may be configured to, with the one or more processors 611, cause the apparatus 610 at least to perform any operation of the method as described in connection with FIG. 5. Alternatively or additionally, the one or more memories 612 and the computer program codes 613 may be configured to, with the one or more processors 611, cause the apparatus 610 at least to perform more or less operations to implement the proposed methods according to the exemplary embodiments of the present disclosure.

FIG. 6B is a block diagram illustrating an apparatus 620 according to some embodiments of the present disclosure. As shown in FIG. 6B, the apparatus 620 may comprise a performing unit 621 and a determining unit 622. In an exemplary embodiment, the apparatus 620 may be implemented in a UE. The performing unit 621 may be operable to carry out the operation in block 302, and the determining unit 622 may be operable to carry out the operation in block 304. Optionally, the performing unit 621 and/or the determining unit 622 may be operable to carry out more or less operations to implement the proposed methods according to the exemplary embodiments of the present disclosure.

FIG. 6C is a block diagram illustrating an apparatus 630 according to some embodiments of the present disclosure. As shown in FIG. 6C, the apparatus 630 may comprise an obtaining unit 631 and a detecting unit 632. In an exemplary embodiment, the apparatus 630 may be implemented in a UE. The obtaining unit 631 may be operable to carry out the operation in block 402, and the detecting unit 632 may be operable to carry out the operation in block 404. Optionally, the obtaining unit 631 and/or the detecting unit 632 may be operable to carry out more or less operations to implement the proposed methods according to the exemplary embodiments of the present disclosure.

FIG. 6D is a block diagram illustrating an apparatus 640 according to some embodiments of the present disclosure. As shown in FIG. 6D, the apparatus 640 may comprise a determining unit 641 and a transmitting unit 642. In an exemplary embodiment, the apparatus 640 may be implemented in a communication node. The determining unit 641 may be operable to carry out the operation in block 502, and the transmitting unit 642 may be operable to carry out the operation in block 504. Optionally, the determining unit 641 and/or the transmitting unit 642 may be operable to carry out more or less operations to implement the proposed methods according to the exemplary embodiments of the present disclosure.

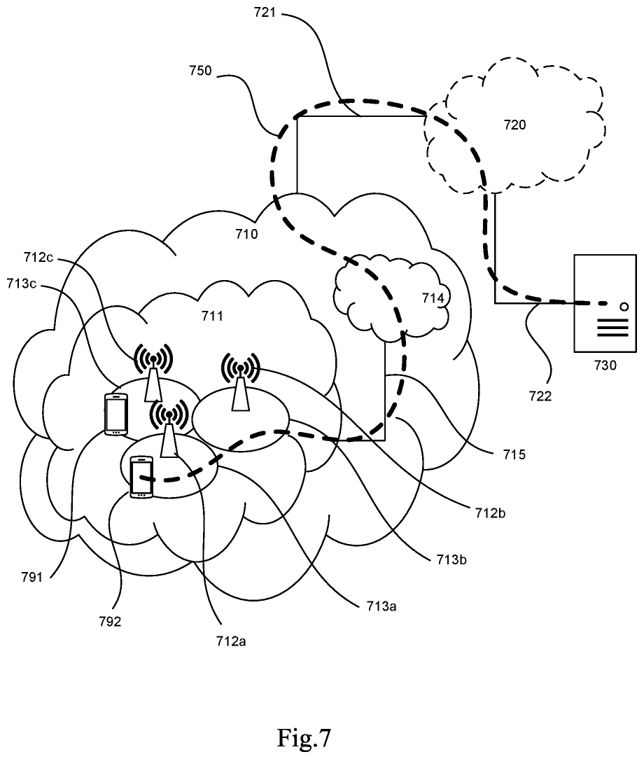

FIG. 7 is a block diagram illustrating a telecommunication network connected via an intermediate network to a host computer in accordance with some embodiments of the present disclosure.

With reference to FIG. 7, in accordance with an embodiment, a communication system includes a telecommunication network 710, such as a 3GPP-type cellular network, which comprises an access network 711, such as a radio access network, and a core network 714. The access network 711 comprises a plurality of base stations 712a, 712b, 712c, such as NBs, eNBs, gNBs or other types of wireless access points, each defining a corresponding coverage area 713a, 713b, 713c. Each base station 712a, 712b, 712c is connectable to the core network 714 over a wired or wireless connection 715. A first UE 791 located in a coverage area 713c is configured to wirelessly connect to, or be paged by, the corresponding base station 712c. A second UE 792 in a coverage area 713a is wirelessly connectable to the corresponding base station 712a. While a plurality of UEs 791, 792 are illustrated in this example, the disclosed embodiments are equally applicable to a situation where a sole UE is in the coverage area or where a sole UE is connecting to the corresponding base station 712.

The telecommunication network 710 is itself connected to a host computer 730, which may be embodied in the hardware and/or software of a standalone server, a cloud-implemented server, a distributed server or as processing resources in a server farm. The host computer 730 may be under the ownership or control of a service provider, or may be operated by the service provider or on behalf of the service provider. Connections 721 and 722 between the telecommunication network 710 and the host computer 730 may extend directly from the core network 714 to the host computer 730 or may go via an optional intermediate network 720. An intermediate network 720 may be one of, or a combination of more than one of, a public, private or hosted network; the intermediate network 720, if any, may be a backbone network or the Internet; in particular, the intermediate network 720 may comprise two or more sub-networks (not shown).

The communication system of FIG. 7 as a whole enables connectivity between the connected UEs 791, 792 and the host computer 730. The connectivity may be described as an over-the-top (OTT) connection 750. The host computer 730 and the connected UEs 791, 792 are configured to communicate data and/or signaling via the OTT connection 750, using the access network 711, the core network 714, any intermediate network 720 and possible further infrastructure (not shown) as intermediaries. The OTT connection 750 may be transparent in the sense that the participating communication devices through which the OTT connection 750 passes are unaware of routing of uplink and downlink communications. For example, the base station 712 may not or need not be informed about the past routing of an incoming downlink communication with data originating from the host computer 730 to be forwarded (e.g., handed over) to a connected UE 791. Similarly, the base station 712 need not be aware of the future routing of an outgoing uplink communication originating from the UE 791 towards the host computer 730.

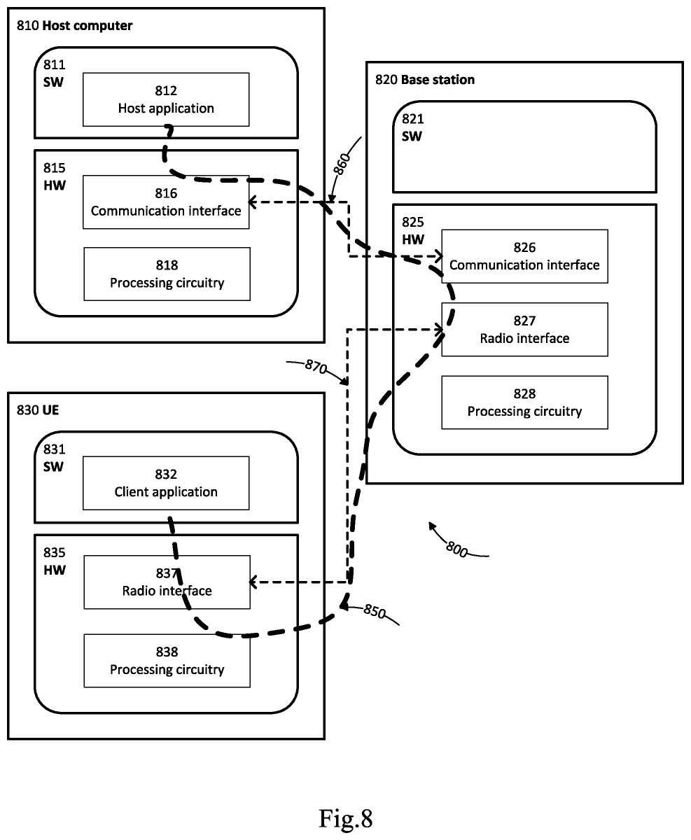

FIG. 8 is a block diagram illustrating a host computer communicating via a base station with a UE over a partially wireless connection in accordance with some embodiments of the present disclosure.

Example implementations, in accordance with an embodiment, of the UE, base station and host computer discussed in the preceding paragraphs will now be described with reference to FIG. 8. In a communication system 800, a host computer 810 comprises hardware 815 including a communication interface 816 configured to set up and maintain a wired or wireless connection with an interface of a different communication device of the communication system 800. The host computer 810 further comprises a processing circuitry 818, which may have storage and/or processing capabilities. In particular, the processing circuitry 818 may comprise one or more programmable processors, application-specific integrated circuits, field programmable gate arrays or combinations of these (not shown) adapted to execute instructions. The host computer 810 further comprises software 811, which is stored in or accessible by the host computer 810 and executable by the processing circuitry 818. The software 811 includes a host application 812. The host application 812 may be operable to provide a service to a remote user, such as UE 830 connecting via an OTT connection 850 terminating at the UE 830 and the host computer 810. In providing the service to the remote user, the host application 812 may provide user data which is transmitted using the OTT connection 850.

The communication system 800 further includes a base station 820 provided in a telecommunication system and comprising hardware 825 enabling it to communicate with the host computer 810 and with the UE 830. The hardware 825 may include a communication interface 826 for setting up and maintaining a wired or wireless connection with an interface of a different communication device of the communication system 800, as well as a radio interface 827 for setting up and maintaining at least a wireless connection 870 with the UE 830 located in a coverage area (not shown in FIG. 8) served by the base station 820. The communication interface 826 may be configured to facilitate a connection 860 to the host computer 810. The connection 860 may be direct or it may pass through a core network (not shown in FIG. 8) of the telecommunication system and/or through one or more intermediate networks outside the telecommunication system. In the embodiment shown, the hardware 825 of the base station 820 further includes a processing circuitry 828, which may comprise one or more programmable processors, application-specific integrated circuits, field programmable gate arrays or combinations of these (not shown) adapted to execute instructions. The base station 820 further has software 821 stored internally or accessible via an external connection.

The communication system 800 further includes the UE 830 already referred to. Its hardware 835 may include a radio interface 837 configured to set up and maintain a wireless connection 870 with a base station serving a coverage area in which the UE 830 is currently located. The hardware 835 of the UE 830 further includes a processing circuitry 838, which may comprise one or more programmable processors, application-specific integrated circuits, field programmable gate arrays or combinations of these (not shown) adapted to execute instructions. The UE 830 further comprises software 831, which is stored in or accessible by the UE 830 and executable by the processing circuitry 838. The software 831 includes a client application 832. The client application 832 may be operable to provide a service to a human or non-human user via the UE 830, with the support of the host computer 810. In the host computer 810, an executing host application 812 may communicate with the executing client application 832 via the OTT connection 850 terminating at the UE 830 and the host computer 810. In providing the service to the user, the client application 832 may receive request data from the host application 812 and provide user data in response to the request data. The OTT connection 850 may transfer both the request data and the user data. The client application 832 may interact with the user to generate the user data that it provides.

It is noted that the host computer 810, the base station 820 and the UE 830 illustrated in FIG. 8 may be similar or identical to the host computer 730, one of base stations 712a, 712b, 712c and one of UEs 791, 792 of FIG. 7, respectively. This is to say, the inner workings of these entities may be as shown in FIG. 8 and independently, the surrounding network topology may be that of FIG. 7.

In FIG. 8, the OTT connection 850 has been drawn abstractly to illustrate the communication between the host computer 810 and the UE 830 via the base station 820, without explicit reference to any intermediary devices and the precise routing of messages via these devices. Network infrastructure may determine the routing, which it may be configured to hide from the UE 830 or from the service provider operating the host computer 810, or both. While the OTT connection 850 is active, the network infrastructure may further take decisions by which it dynamically changes the routing (e.g., on the basis of load balancing consideration or reconfiguration of the network).

Wireless connection 870 between the UE 830 and the base station 820 is in accordance with the teachings of the embodiments described throughout this disclosure. One or more of the various embodiments improve the performance of OTT services provided to the UE 830 using the OTT connection 850, in which the wireless connection 870 forms the last segment. More precisely, the teachings of these embodiments may improve the latency and the power consumption, and thereby provide benefits such as lower complexity, reduced time required to access a cell, better responsiveness, extended battery lifetime, etc.

A measurement procedure may be provided for the purpose of monitoring data rate, latency and other factors on which the one or more embodiments improve. There may further be an optional network functionality for reconfiguring the OTT connection 850 between the host computer 810 and the UE 830, in response to variations in the measurement results. The measurement procedure and/or the network functionality for reconfiguring the OTT connection 850 may be implemented in software 811 and hardware 815 of the host computer 810 or in software 831 and hardware 835 of the UE 830, or both. In embodiments, sensors (not shown) may be deployed in or in association with communication devices through which the OTT connection 850 passes; the sensors may participate in the measurement procedure by supplying values of the monitored quantities exemplified above, or supplying values of other physical quantities from which the software 811, 831 may compute or estimate the monitored quantities. The reconfiguring of the OTT connection 850 may include message format, retransmission settings, preferred routing etc.; the reconfiguring need not affect the base station 820, and it may be unknown or imperceptible to the base station 820. Such procedures and functionalities may be known and practiced in the art. In certain embodiments, measurements may involve proprietary UE signaling facilitating the host computer 810's measurements of throughput, propagation times, latency and the like. The measurements may be implemented in that the software 811 and 831 causes messages to be transmitted, in particular empty or ‘dummy’ messages, using the OTT connection 850 while it monitors propagation times, errors etc.

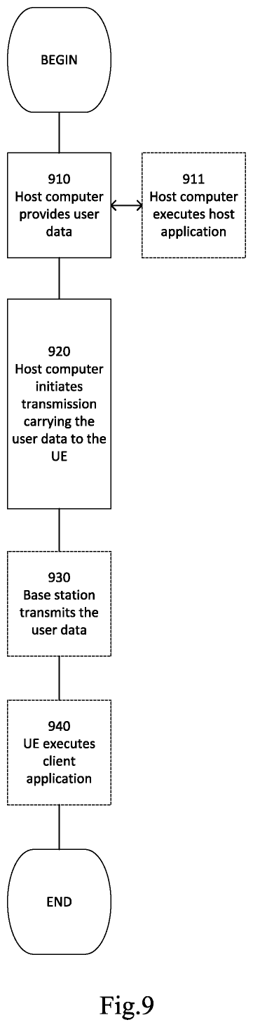

FIG. 9 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 9 will be included in this section. In step 910, the host computer provides user data. In substep 911 (which may be optional) of step 910, the host computer provides the user data by executing a host application. In step 920, the host computer initiates a transmission carrying the user data to the UE. In step 930 (which may be optional), the base station transmits to the UE the user data which was carried in the transmission that the host computer initiated, in accordance with the teachings of the embodiments described throughout this disclosure. In step 940 (which may also be optional), the UE executes a client application associated with the host application executed by the host computer.

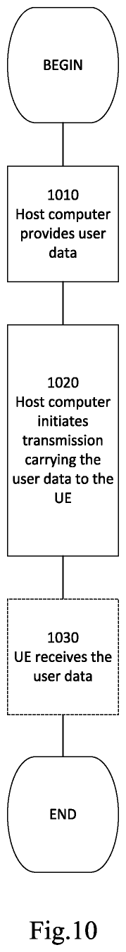

FIG. 10 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 10 will be included in this section. In step 1010 of the method, the host computer provides user data. In an optional substep (not shown) the host computer provides the user data by executing a host application. In step 1020, the host computer initiates a transmission carrying the user data to the UE. The transmission may pass via the base station, in accordance with the teachings of the embodiments described throughout this disclosure. In step 1030 (which may be optional), the UE receives the user data carried in the transmission.

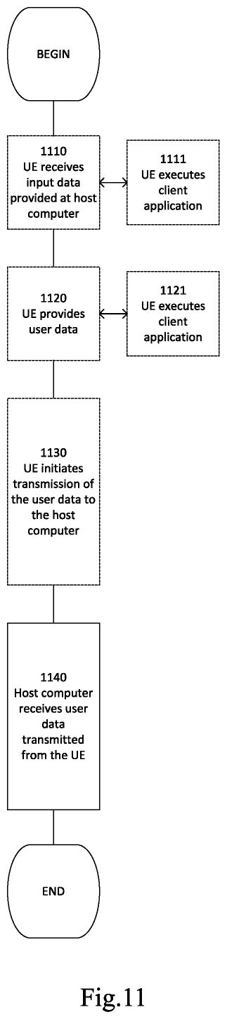

FIG. 11 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 11 will be included in this section. In step 1110 (which may be optional), the UE receives input data provided by the host computer. Additionally or alternatively, in step 1120, the UE provides user data. In substep 1121 (which may be optional) of step 1120, the UE provides the user data by executing a client application. In substep 1111 (which may be optional) of step 1110, the UE executes a client application which provides the user data in reaction to the received input data provided by the host computer. In providing the user data, the executed client application may further consider user input received from the user. Regardless of the specific manner in which the user data was provided, the UE initiates, in substep 1130 (which may be optional), transmission of the user data to the host computer. In step 1140 of the method, the host computer receives the user data transmitted from the UE, in accordance with the teachings of the embodiments described throughout this disclosure.

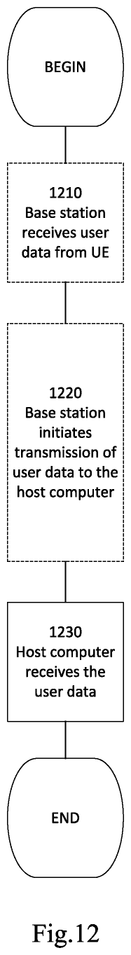

FIG. 12 is a flowchart illustrating a method implemented in a communication system, in accordance with an embodiment. The communication system includes a host computer, a base station and a UE which may be those described with reference to FIG. 7 and FIG. 8. For simplicity of the present disclosure, only drawing references to FIG. 12 will be included in this section. In step 1210 (which may be optional), in accordance with the teachings of the embodiments described throughout this disclosure, the base station receives user data from the UE. In step 1220 (which may be optional), the base station initiates transmission of the received user data to the host computer. In step 1230 (which may be optional), the host computer receives the user data carried in the transmission initiated by the base station.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station which may perform any step of the exemplary method 500 as described with respect to FIG. 5.

According to some exemplary embodiments, there is provided a communication system including a host computer. The host computer may comprise processing circuitry configured to provide user data, and a communication interface configured to forward the user data to a cellular network for transmission to a UE. The cellular network may comprise a base station having a radio interface and processing circuitry. The base station's processing circuitry may be configured to perform any step of the exemplary method 500 as described with respect to FIG. 5.

According to some exemplary embodiments, there is provided a method implemented in a communication system which may include a host computer, a base station and a UE. The method may comprise providing user data at the host computer. Optionally, the method may comprise, at the host computer, initiating a transmission carrying the user data to the UE via a cellular network comprising the base station. The UE may perform any step of the exemplary method 300 as described with respect to FIG. 3, or any step of the exemplary method 400 as described with respect to FIG. 4, or any step of the exemplary method 500 as described with respect to FIG. 5.

According to some exemplary embodiments, there is provided a communication system including a host computer. The host computer may comprise processing circuitry configured to provide user data, and a communication interface configured to forward user data to a cellular network for transmission to a UE. The UE may comprise a radio interface and processing circuitry. The UE's processing circuitry may be configured to perform any step of the exemplary method 300 as described with respect to FIG. 3, or any step of the exemplary method 400 as described with respect to FIG. 4, or any step of the exemplary method 500 as described with respect to FIG. 5.

According to some exemplary embodiments, there is provided a method implemented in a communication system which may include a host computer, a base station and a UE. The method may comprise, at the host computer, receiving user data transmitted to the base station from the UE which may perform any step of the exemplary method 300 as described with respect to FIG. 3, or any step of the exemplary method 400 as described with respect to FIG. 4, or any step of the exemplary method 500 as described with respect to FIG. 5.

According to some exemplary embodiments, there is provided a communication system including a host computer. The host computer may comprise a communication interface configured to receive user data originating from a transmission from a UE to a base station. The UE may comprise a radio interface and processing circuitry. The UE's processing circuitry may be configured to perform any step of the exemplary method 300 as described with respect to FIG. 3, or any step of the exemplary method 400 as described with respect to FIG. 4, or any step of the exemplary method 500 as described with respect to FIG. 5.

According to some exemplary embodiments, there is provided a method implemented in a communication system which may include a host computer, a base station and a UE. The method may comprise, at the host computer, receiving, from the base station, user data originating from a transmission which the base station has received from the UE. The base station may perform any step of the exemplary method 500 as described with respect to FIG. 5.

According to some exemplary embodiments, there is provided a communication system which may include a host computer. The host computer may comprise a communication interface configured to receive user data originating from a transmission from a UE to a base station. The base station may comprise a radio interface and processing circuitry. The base station's processing circuitry may be configured to perform any step of the exemplary method 500 as described with respect to FIG. 5.

In general, the various exemplary embodiments may be implemented in hardware or special purpose chips, circuits, software, logic or any combination thereof. For example, some aspects may be implemented in hardware, while other aspects may be implemented in firmware or software which may be executed by a controller, microprocessor or other computing device, although the disclosure is not limited thereto. While various aspects of the exemplary embodiments of this disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As such, it should be appreciated that at least some aspects of the exemplary embodiments of the disclosure may be practiced in various components such as integrated circuit chips and modules. It should thus be appreciated that the exemplary embodiments of this disclosure may be realized in an apparatus that is embodied as an integrated circuit, where the integrated circuit may comprise circuitry (as well as possibly firmware) for embodying at least one or more of a data processor, a digital signal processor, baseband circuitry and radio frequency circuitry that are configurable so as to operate in accordance with the exemplary embodiments of this disclosure.

It should be appreciated that at least some aspects of the exemplary embodiments of the disclosure may be embodied in computer-executable instructions, such as in one or more program modules, executed by one or more computers or other devices. Generally, program modules include routines, programs, objects, components, data structures, etc. that perform particular tasks or implement particular abstract data types when executed by a processor in a computer or other device. The computer executable instructions may be stored on a computer readable medium such as a hard disk, optical disk, removable storage media, solid state memory, random access memory (RAM), etc. As will be appreciated by one of skill in the art, the function of the program modules may be combined or distributed as desired in various embodiments. In addition, the function may be embodied in whole or partly in firmware or hardware equivalents such as integrated circuits, field programmable gate arrays (FPGA), and the like.

The present disclosure includes any novel feature or combination of features disclosed herein either explicitly or any generalization thereof. Various modifications and adaptations to the foregoing exemplary embodiments of this disclosure may become apparent to those skilled in the relevant arts in view of the foregoing description, when read in conjunction with the accompanying drawings. However, any and all modifications will still fall within the scope of the non-limiting and exemplary embodiments of this disclosure.

1.-51. (canceled)

52. A method performed by a user equipment (UE), the method comprising:
obtaining configuration information related to a slot group comprising multiple slots for sidelink (SL) transmissions, wherein the configuration information indicates one or more of the following: a time gap between a slot group for initial SL transmission and a slot group for SL retransmission, and a time interval between two consecutive slot groups for initial SL transmissions;
performing a listen-before-talk (LBT) operation prior to the slot group; and
based on a result of the LBT operation, determining whether to select one or more slots from the multiple slots, of the slot group, for one or more SL transmissions towards one or more other UEs.

53. The method according to claim 52, wherein when the LBT operation succeeds prior to or during the slot group:
the UE determines to select the one or more slots from the multiple slots for the one or more SL transmissions; and
the method further comprises performing the one or more SL transmissions in the one or more selected slots.

54. The method according to claim 53, wherein when the LBT operation succeeds prior to the slot group, the one or more selected slots in which the UE performs the one or more SL transmissions start from a beginning slot in the slot group.

55. The method according to claim 53, wherein when the LBT operation succeeds during an n-th slot in the slot group, the one or more selected slots in which the UE performs the one or more SL transmissions start from an (n+1)-th slot in the slot group, where n is an integer equal to or larger than 1 and less than a number of slots in the slot group.

56. The method according to claim 53, wherein the one or more selected slots include two consecutive slots, and the method further comprises performing one or more of the following to enable the two consecutive slots to be used for a different services, quality-of-service (QOS) flows, logical channels (LCHs), or logical channel groups (LCGs):
mapping first and second services to different quality-of-service (QOS) flows, when a maximum number of slots used for transmission is configured per service;
mapping first and second QoS flows to different bearers, when a maximum number of slots used for transmission is configured per QoS flow;
mapping first and second bearers to different logical channels (LCHs), when a maximum number of slots used for transmission is configured per bearer; and
excluding a first LCH or LCG from a logical channel prioritization (LCP) procedure in one of the two consecutive slots which is to be used for a second LCH or LCG.

57. The method according to claim 53, further comprising transmitting SL control information (SCI) including one or more of the following:
an index indicating a position, within the slot group, of a slot in which the SCI is sent; and
a rest number of slots, within the slot group, after the slot in which the SCI is sent.

58. The method according to claim 52, wherein when the LBT operation succeeds during a last slot in the slot group or consistently fails during the multiple slots in the slot group, the UE determines not to select any slot from the multiple slots for the one or more SL transmissions.

59. The method according to claim 52, wherein one or more of the following applies:
the multiple slots in the slot group are consecutive slots for at least one of the following: initial transmission, and retransmission; and
the one or more SL transmissions include at least one of the following: one or more initial transmissions, and one or more retransmissions.

60. The method according to claim 52, wherein:
the UE is configured with two or more slot groups and performs the LBT operation per slot group; and
the two or more slot groups include one or more of the following: one or more slot groups for initial SL transmission, and one or more slot groups for SL retransmission.

61. The method according to claim 52, wherein:
the time gap between the slot group for the initial SL transmission and the slot group for the SL retransmission is based on expected timing of a hybrid automatic repeat request (HARQ) acknowledgement of the initial SL transmission; and
the time interval between the two consecutive slot groups for the initial SL transmissions is based at least in part on a time interval of data arrival.

62. The method according to claim 52, wherein the configuration information is based at least in part on one or more of:
channel occupancy;
a channel busy ratio (CBR);
a channel usage ratio (CR);
a received signal strength indicator (RSSI);
a number of LBT failures;
a number of LBT success occasions;
an LBT failure ratio;
an LBT success ratio;
one or more quality-of-service (QOS) requirements of a service, a bearer, a QoS flow, a logical channel (LCH), or a logical channel group (LCG); and
a priority of the service, the QoS flow, the bearer, the LCH, or the LCG.

63. The method according to claim 52, wherein the slot group is one of the following:
a periodic slot group configured to the UE via one or more of the following: a configured grant for SL transmission, and a Mode 2 resource allocation with resource reservation; or
the slot group is configured to be available for non-periodic traffic of the UE.

64. A user equipment (UE) comprising:
one or more processors; and
one or more memories storing computer program code that, when executed by the one or more processors, cause the UE to:
obtain configuration information related to a slot group comprising multiple slots for sidelink (SL) transmissions, wherein the configuration information indicates one or more of the following: a time gap between a slot group for initial SL transmission and a slot group for SL retransmission, and a time interval between two consecutive slot groups for initial SL transmissions;
perform a listen-before-talk (LBT) operation prior to the slot group; and
based on a result of the LBT operation, determine whether to select one or more slots from the multiple slots, of the slot group, for one or more SL transmissions towards one or more other UEs.

65. A method performed by a user equipment (UE), the method comprising:
obtaining configuration information related to a slot group comprising multiple slots for sidelink (SL) transmissions, wherein the configuration information indicates one or more of the following: a time gap between a slot group for initial SL transmission and a slot group for SL retransmission, and a time interval between two consecutive slot groups for initial SL transmissions; and
detecting one or more SL transmissions from another UE in one or more slots of the multiple slots of the slot group, based at least in part on the configuration information.

66. The method according to claim 65, wherein one or more of the following applies:
the multiple slots in the slot group are consecutive slots for at least one of the following: initial transmission, and retransmission; and
the one or more SL transmissions include at least one of the following: one or more initial transmissions, and one or more retransmissions.

67. The method according to claim 65, further comprising, in response to receiving at least one of the detected one or more SL transmissions from the other UE, sending one or more acknowledgements of the received SL transmissions to the other UE.

68. The method according to claim 65, wherein:
the time gap between the slot group for the initial SL transmission and the slot group for the SL retransmission is based on expected timing of a hybrid automatic repeat request (HARQ) acknowledgement by the UE of the initial SL transmission; and
the time interval between the two consecutive slot groups for the initial SL transmissions is based at least in part on a time interval of data arrival.

69. The method according to claim 65, wherein the configuration information is based at least in part on one or more of:
channel occupancy;
a channel busy ratio (CBR);
a channel usage ratio (CR);
a received signal strength indicator (RSSI);
a number of LBT failures;
a number of LBT success occasions;
an LBT failure ratio;
an LBT success ratio;
one or more quality-of-service (QOS) requirements of a service, a bearer, a QoS flow, a logical channel (LCH), or a logical channel group (LCG); and
a priority of the service, the QoS flow, the bearer, the LCH, or the LCG.

70. The method according to claim 65, further comprising receiving, from the other UE, SL control information (SCI) that includes one or more of the following:
an index indicating a position of a slot, within the slot group, in which the SCI is received; and
an indication of a rest number of slots, within the slot group, after the slot in which the SCI is received.

71. User equipment (UE) comprising:
one or more processors; and
one or more memories storing computer program code that, when executed by the one or more processors, cause the UE to perform the method of claim 65.
